(19) United States
(12) Patent Application Publication
(10) Pub. No.: US 2017/0272955 A1
(43) Pub. Date: Sep. 21, 2017

(54) COMMUNICATION PATTERN DETECTION FOR UNLICENSED RADIO FREQUENCY SPECTRUM BANDS

(71) Applicant: QUALCOMM Incorporated, San Diego, CA (US)

(72) Inventors: Ahmed Kamel Sadek, San Diego, CA (US); Rahul Malik, San Diego, CA (US); Sameer Vermani, San Diego, CA (US); Didier Johannes Richard van Nee, Tull en 't Waal (NL)

(21) Appl. No.: 15/074,971

(22) Filed: Mar. 18, 2016

(51) Int. Cl. H04W 16/14

(52) U.S. Cl. CPC H04W 16/14

(57) ABSTRACT

Methods, systems, and devices for wireless communication are described. A device using a first radio access technology (RAT) to communicate over an unlicensed radio frequency spectrum band may identify a communication pattern for a transmission using a second RAT over the unlicensed radio frequency spectrum band. The identification may be based at least in part on signaling received by the device. The device may determine, based at least in part on the communication pattern, a time period for attempting to transmit the unlicensed radio frequency spectrum band using the first RAT.

### BACKGROUND

The present disclosure relates generally to wireless communication, and more specifically to communication pattern detection for unlicensed radio frequency spectrum bands.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN) (e.g., IEEE 802.11) may include access point (AP) that may communicate with one or more stations (STAs) or mobile devices. The AP may be coupled to a network, such as the Internet, and may enable a STA to communicate via the network (or communicate with other devices coupled to the AP). A device may communicate with a network device bi-directionally. For example, in a WLAN, a STA may communicate with an associated AP via downlink (DL) and/or uplink (UL). The DL (or forward link) may refer to the communication link from the AP to the station, and the UL (or reverse link) may refer to the communication link from the station to the AP.

A device in the WLAN may communicate using a first radio access technology (RAT) (e.g., Wi-Fi) over an unlicensed channel. The device using the first RAT may attempt accessing the unlicensed channel according to the contention rules associated with the unlicensed channel. In some cases, devices using a second RAT (e.g., Long Term Evolution (LTE) or a version of LTE customized for use wholly or partially in the unlicensed spectrum) may access the unlicensed channel. For example, the devices using the second RAT may offload communications from a licensed channel to the unlicensed channel. In such cases, communications associated from the devices using the second RAT may interfere with the communications associated with the devices using the first RAT. Additionally, communications from the devices using the second RAT may prevent devices using the first RAT from accessing the unlicensed channel.

### SUMMARY

A device using a first radio access technology (RAT) may communicate with other devices by sending signals over an unlicensed channel. The device using the first RAT may identify a communication pattern of a device that is transmitting using a second RAT. For example, a device using Wi-Fi technology (e.g., technology using IEEE 802.11 communication protocols) may identify the communication pattern of a device that is using Long Term Evolution (LTE) technology (e.g., technology using licensed spectrum LTE protocols or versions of LTE protocols customized for use wholly or partially in the unlicensed spectrum). The communication pattern may include an active period during which the device using the second RAT accesses the unlicensed channel, and an inactive period during which the device using the second RAT does not access the unlicensed channel. For example, the communication may be a carrier sensing adaptive transmission (CSAT) pattern. The device using the first RAT may identify the communication pattern based on signaling received by the device using the first RAT. For example, a first device using the first RAT may receive, from a second device using the first RAT, channel state information (CSI) associated with the unlicensed channel. The CSI may be sent by the second device in response to a polling packet (e.g., a null data packet (NDP)) sent to the second device over the unlicensed channel by the first device. The CSI may include signal-to-noise-plus-interference ratio (SINR) information. The first device using the first RAT may evaluate the SINR to determine the communication pattern. In some cases, the first device using the first RAT may evaluate the strength of a received signal sent using the first RAT to determine the communication pattern. In some examples, the first device using the first RAT may receive an explicit indication of the communication pattern. The explicit indication may be sent from a second device using the first RAT or a device using the second RAT. In some examples, the first device using the first RAT may identify the communication pattern by detecting the presence of signals on the unlicensed channel that were sent using the second RAT.

The device using the first RAT may then communicate based on the communication pattern that it has identified. For example, the device may schedule a transmission to occur during an inactive period of the communication pattern. In some cases, the device may schedule a transmission to occur on a different channel than the unlicensed channel during an active period of the communication pattern. In some examples, the device may use single-user multiple input-multiple output (SU-MIMO) for transmissions during active periods of the communication pattern, and multi-user MIMO (MU-MIMO) during inactive periods of the communication pattern. In other examples, the device may use a first modulation and coding scheme (MCS) for transmissions during an inactive period of the communication pattern, and a second MCS during an active period of the communication pattern. In some cases, the first MCS for the inactive period may be higher than the second MCS for the active period. In some cases, a device using the second RAT may communicate using the communication pattern for a portion, but not necessarily all, of the system bandwidth used by the device using the first RAT. In such cases, the device using the first RAT may identify the portion of system bandwidth affected by the communication pattern, in addition to identifying the communication pattern itself. The device using the first RAT may then avoid transmitting over the affected portion of bandwidth during an active period of the communication pattern, and may transmit over both the affected portion of bandwidth and an unaffected portion of bandwidth, if any, during an inactive period of the communication pattern.

A method of wireless communication is described. The method may include identifying, by a device using a first RAT to communicate over an unlicensed radio frequency (RF) spectrum band, a communication pattern for a transmission using a second RAT over the unlicensed RF spectrum band based at least in part on signaling received by the device and determining, based at least in part on the communication pattern, a first time period for attempting to transmit by the device over the unlicensed RF spectrum band using the first RAT.

An apparatus for wireless communication is described. The apparatus may include means for identifying, by a device using a first RAT to communicate over an unlicensed RF spectrum band, a communication pattern for a transmission using a second RAT over the unlicensed RF spectrum band based at least in part on signaling received by the device and means for determining, based at least in part on the communication pattern, a first time period for attempting to transmit by the device over the unlicensed RF spectrum band using the first RAT.

A further apparatus is described. The apparatus may include a processor, memory in electronic communication with the processor, and instructions stored in the memory. The instructions may be operable, when executed by the processor, to cause apparatus to identify, by a device using a first RAT to communicate over an unlicensed RF spectrum band, a communication pattern for a transmission using a second RAT over the unlicensed RF spectrum band based at least in part on signaling received by the device and determine, based at least in part on the communication pattern, a first time period for attempting to transmit by the device over the unlicensed RF spectrum band using the first RAT.

A non-transitory computer readable medium for wireless communication is described. The non-transitory computer-readable medium may include instructions to cause a processor to identify, by a device using a first RAT to communicate over an unlicensed RF spectrum band, a communication pattern for a transmission using a second RAT over the unlicensed RF spectrum band based on signaling received by the device and determine, based on the communication pattern, a first time period for attempting to transmit by the device over the unlicensed RF spectrum band using the first RAT.

In some examples of the method, apparatus, or non-transitory computer-readable medium described above, the first RAT comprises Wi-Fi technology. In some examples of the method, apparatus, or non-transitory computer-readable medium described above, the communication pattern comprises a cyclical active period of time that WWAN signaling is present on the unlicensed RF spectrum band and a cyclical inactive period of time that WWAN signaling is not present on the unlicensed RF spectrum band.

In some examples of the method, apparatus, or non-transitory computer-readable medium described above, the second RAT comprises LTE technology. Some examples of the method, apparatus, or non-transitory computer-readable medium described above may further include processes, features, means, or instructions for transmitting an NDP from the device. Some examples of the method, apparatus, or non-transitory computer-readable medium described above may further include processes, features, means, or instructions for receiving, at the device, a CSI message in response to the NDP, the CSI message comprising interference information associated with the unlicensed RF spectrum band, where the signaling comprises the indication of the interference information. In some cases, the interference information includes an indication of a signal-to-interference-plus-noise ratio (SINR) or a signal-to-noise ratio (SNR). The SINR may be narrowband SINR associated with a portion of the unlicensed RF spectrum band used by the device.

Some examples of the method, apparatus, or non-transitory computer-readable medium described above may further include processes, features, means, or instructions for determining that the communication pattern affects a first portion of bandwidth used by the device more than a second portion of bandwidth used by the device, where the first bandwidth portion and the second portion of bandwidth comprise at least a portion of the unlicensed RF spectrum band. Some examples of the method, apparatus, or non-transitory computer-readable medium described above may further include processes, features, means, or instructions for transmitting by the device using the second portion of bandwidth during an active time period of the communication pattern. Some examples of the method, apparatus, or non-transitory computer-readable medium described above may further include processes, features, means, or instructions for delaying a transmission over the first portion of bandwidth during the first time period.

Some examples of the method, apparatus, or non-transitory computer-readable medium described above may further include processes, features, means, or instructions for selecting, for the device using the first RAT, a first MCS to use to transmit during an active time period of the communication pattern, where the first MCS is lower than a second MCS to use for transmissions during the first time period. In some examples of the method, apparatus, or non-transitory computer-readable medium described above, identifying the communication pattern includes detecting a wireless wide area network (WWAN) pilot signal sent over the unlicensed RF spectrum band. The WWAN pilot signal may include at least a WWAN primary synchronization signal (PSS), or a WWAN secondary synchronization signal (SSS), or a WWAN cell-specific reference signal (CRS), or a combination thereof.

In some examples of the method, apparatus, or non-transitory computer-readable medium described above, identifying the communication pattern includes evaluating a received signal strength indicator (RSSI) corresponding to the signaling, where the signaling is sent over the unlicensed RF spectrum band. Some examples of the method, apparatus, or non-transitory computer-readable medium described above may further include processes, features, means, or instructions for comparing the RSSI to a threshold. Some examples may include determining whether WWAN signaling is present on the unlicensed RF spectrum band based on the comparison.

Some examples of the method, apparatus, or non-transitory computer-readable medium described above may further include processes, features, means, or instructions for transmitting an indication of the determined communication pattern to a wireless local area network (WLAN) access point (AP), where the device is a station (STA) of the WLAN. In some examples of the method, apparatus, or non-transitory computer-readable medium described above, the device is a WLAN AP. Some examples of the method, apparatus, or non-transitory computer-readable medium described above may further include processes, features, means, or instructions for configuring the WLAN AP to transmit a single-user MIMO (SU-MIMO) transmission during the first time period. Some examples of the method, apparatus, or non-transitory computer-readable medium described above may further include processes, features, means, or instructions for configuring the WLAN AP to transmit a multi-user MIMO transmission during a second time period, wherein the first time period comprises an active time period of the communication pattern and the second time period comprises an inactive time period of the communication pattern.

Some examples of the method, apparatus, or non-transitory computer-readable medium described above may further include processes, features, means, or instructions for determining that a first set of WLAN devices served by the WLAN AP is more affected by the communication pattern than a second set of WLAN devices served by the WLAN AP. Some examples of the method, apparatus, or non-transitory computer-readable medium described above may further include processes, features, means, or instructions for transmitting to the second set of WLAN devices during an active time period of the communication pattern. Some examples of the method, apparatus, or non-transitory computer-readable medium described above may further include processes, features, means, or instructions for delaying transmitting to the first set of WLAN devices to during the first time period.

### BRIEF DESCRIPTION OF THE DRAWINGS

FIG. 1 illustrates an example of a wireless communications system that supports communication pattern detection for unlicensed radio frequency spectrum bands in accordance with aspects of the present disclosure;

FIG. 2 illustrates an example of a wireless communications subsystem that supports communication pattern detection for unlicensed radio frequency spectrum bands in accordance with aspects of the present disclosure;

FIG. 3A illustrates an example of a wideband communication pattern that supports communication pattern detection for unlicensed radio frequency spectrum bands in accordance with aspects of the present disclosure;

FIG. 3B illustrates an example of an unlicensed radio frequency spectrum band that supports communication pattern detection for unlicensed radio frequency spectrum bands in accordance with aspects of the present disclosure;

FIG. 4 illustrates an example of a communications timing diagram that supports communication pattern detection for unlicensed radio frequency spectrum bands in accordance with aspects of the present disclosure;

FIG. 5 illustrates an example of a process flow in a system that supports communication pattern detection for unlicensed radio frequency spectrum bands in accordance with aspects of the present disclosure;

FIG. 6 illustrates an example of a process flow that supports communication pattern detection for unlicensed radio frequency spectrum bands in accordance with aspects of the present disclosure;

FIG. 7A illustrates an example of a process flow in a system that supports communication pattern detection for unlicensed radio frequency spectrum bands in accordance with aspects of the present disclosure;

FIG. 7B illustrates an example of a process flow that supports communication pattern detection for unlicensed radio frequency spectrum bands in accordance with aspects of the present disclosure;

FIGS. 8-9 show block diagrams of a device that supports communication pattern detection for unlicensed radio frequency spectrum bands in accordance with aspects of the present disclosure;

FIG. 10 shows a block diagram of a communication pattern manager that supports communication pattern detection for unlicensed radio frequency spectrum bands in accordance with aspects of the present disclosure;

FIG. 11 illustrates a block diagram of a system including a device that supports communication pattern detection for unlicensed radio frequency spectrum bands in accordance with aspects of the present disclosure; and

FIGS. 12-14 show flowcharts illustrating methods for communication pattern detection for unlicensed radio frequency spectrum bands in accordance with aspects of the present disclosure.

### DETAILED DESCRIPTION

A wireless device may communicate with one or more other wireless devices by sending and receiving signals over an unlicensed radio frequency spectrum band. The unlicensed spectrum may include frequency bands traditionally used by Wi-Fi technology, such as the 5 GHz band, the 2.4 GHz band, the 60 GHz band, the 3.6 GHz band, and/or the 900 MHz band. The unlicensed spectrum may also include other frequency bands. For example, a device may, using a first radio access technology (RAT) (e.g., Wi-Fi), transmit a message over an unlicensed channel included in the unlicensed radio frequency spectrum band. Devices using the first RAT may have access to the unlicensed channel according to a contention-based protocol. In one example of a contention-based protocol, devices using the first RAT may attempt to access the unlicensed channel if the unlicensed channel is free of traffic, and may refrain from attempting channel access if the unlicensed channel is busy.

In some cases, devices using a second RAT that is different from the first RAT may use the unlicensed channel to communicate. For example, a device using Long Term Evolution (LTE) technology may offload traffic from a licensed channel to the unlicensed channel. If not addressed, traffic from the devices using the second RAT may interfere with the channel access and/or wireless communications of devices using the first RAT. To avoid unfair use of the unlicensed channel, devices using the second RAT may use a communication pattern in which devices from the second RAT are assigned certain time periods during which they are allowed to access the unlicensed channel. For example, devices using the second RAT may be permitted to attempt channel access during certain periods of time (e.g., active periods) and restricted from attempting channel access during other periods of time (e.g., inactive periods). In some cases, the duration of the active period is the same as the duration of the inactive period (e.g., 10 milliseconds for an active period followed by 10 milliseconds for an inactive period). In other cases, the duration of the active and inactive periods may be based on the congestion on the unlicensed channel caused by devices using the first RAT. For example, the active period may be short relative to the inactive period if there is a lot of traffic over the unlicensed channel from devices using the first RAT so that one or more devices using the second RAT do not dominate access to the unlicensed channel. Alternatively, if there is not a lot of traffic over the unlicensed channel from devices using the first RAT, the active period may be longer.

Although implementation of a communication pattern may restrict the use of the unlicensed channel by devices using the second RAT, devices using the first RAT may be unaware of the communication pattern, and may be unaware of the timing of active periods and inactive periods of the communication pattern, and thus continue to transmit on the unlicensed channel even when interference from the second RAT is high (e.g., during one or more active periods of the communication pattern). In some cases, the interference may be low enough to escape detection by devices receiving communications using the first RAT (e.g., by allowing cyclic redundancy check (CRC) to pass) but high enough to adversely affect first RAT communications.

For example, during an active period of the communication pattern, a first device using the first RAT may send a polling packet over the unlicensed channel to a second device using the first RAT. The second device may use the polling packet to make estimations about characteristics (e.g., noise, interference) of the unlicensed channel. The second device may send the channel estimations to the first device, which may use the estimations when generating subsequent transmissions. However, the channel estimations may be corrupted due to interference from second RAT communications during the active period of the communication pattern. Thus, the channel characteristics reported to first device using the first RAT may be inaccurate. If the first device is not able to detect the corruption, the first device may use the corrupted channel estimates to generate corrupted transmissions. For example the first device may generate multi-user multiple input multiple output (MU-MIMO) transmissions, resulting in corrupted MU-MIMO transmissions that incur large overhead when they fail (e.g., by triggering one or more hybrid automatic repeat request (HARQ) processes). As a result, a device using the first RAT may see high interference during an active period which may negatively impact the performance and rate control of the device. For example, it may take the device using the first RAT a duration of time to recognize the interference and switch from MU-MIMO transmissions to single-user MIMO (SU-MIMO) transmissions. Similarly, the device using the first RAT may not be able to readily recognize when an inactive period of the communication pattern occurs, which may result in a long ramp up time for rate control to go back to MU-MIMO transmissions after the end of an active period.

Thus, the first device using the first RAT may implement a communication pattern detection scheme to identify the communication pattern and adjust communications accordingly. The device may adjust communications without waiting to react to a packet error rate (PER). For example, the first device may identify when active periods of the communication pattern occur and delay transmissions over the unlicensed channel until the inactive periods. In other examples, the first device may switch from MU-MIMO transmissions to SU-MIMO during the active periods of the communication pattern. The first device may also modify the rate of a transmission, or which devices to transmit to, based on the communication pattern. By adjusting communication parameters, the first device may mitigate deleterious effects caused by the active periods of the communication pattern.

Aspects of the disclosure are further illustrated by and described with reference to apparatus diagrams, system diagrams, and flowcharts that relate to communication pattern detection for unlicensed radio frequency spectrum bands.

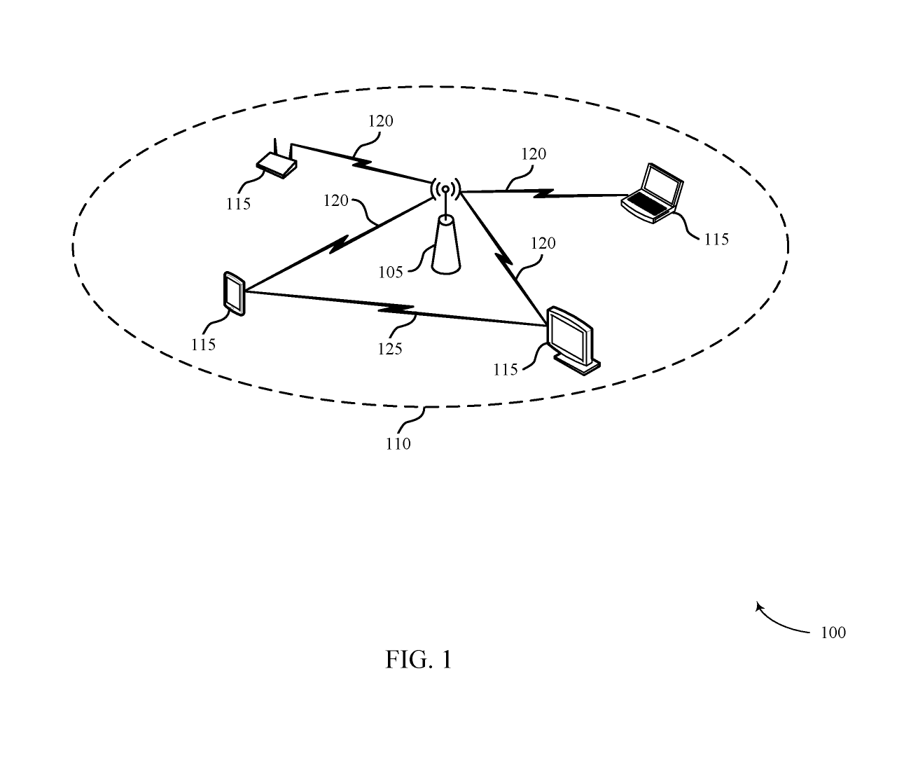

FIG. 1 illustrates an example of a wireless communications system 100 that supports communication pattern detection for unlicensed radio frequency spectrum bands in accordance with various aspects of the present disclosure. The wireless communications system 100 may be an example of a wireless local area network (WLAN) and may include an access point (AP) 105 and multiple associated stations (STAs) 115. The STAs 115 may represent devices such as mobile stations, personal digital assistant (PDAs), other handheld devices, netbooks, notebook computers, tablet computers, laptops, display devices (e.g., TVs, computer monitors, etc.), printers, etc. The various STAs 115 in the wireless communications system 100 are able to communicate with one another through the AP 105. Also shown is a coverage area 110 of the AP 105, which may represent a basic service area (BSA) of the wireless communications system 100. AP 105 may communicate with STAs 115 within the coverage area 110 via communication links 120.

Although not shown in FIG. 1, a STA 115 may be located in the intersection of more than one coverage area 110 and may associate with more than one AP 105. A single AP 105 and an associated set of STAs 115 may be referred to as a basic service set (BSS). An extended service set (ESS) is a set of connected BSSs. A distribution system (DS) (not shown) may be used to connect APs 105 in an ESS. In some cases, the coverage area 110 of an AP 105 may be divided into sectors (also not shown). The wireless communications system 100 may include APs 105 of different types (e.g., metropolitan area, home network, etc.), with varying and overlapping coverage areas 110. Two STAs 115 may also communicate directly via a direct wireless link 125 regardless of whether both STAs 115 are in the same coverage area 110. Examples of direct wireless links 125 may include Wi-Fi Direct connections, Wi-Fi Tunneled Direct Link Setup (TDLS) links, and other group connections. STAs 115 and APs 105 may communicate according to the WLAN radio and baseband protocol for physical (PHY) and medium access control (MAC) layers from IEEE 802.11 and versions including, but not limited to, 802.11b, 802.11g, 802.11a, 802.11n, 802.11ac, 802.11ad, 802.11ah, 802.11ax, etc. In other implementations, peer-to-peer connections or ad hoc networks may be implemented within WLAN network 100.

In some cases, wireless communications system 100 may increase throughput and reliability by supporting transmission techniques such as MIMO and MU-MIMO. A MIMO communication may involve multiple transmitter antennas (e.g., at an AP 105) sending a signal to multiple receive antennas (e.g., at a STA 115). Each transmitting antenna may transmit independent data (or spatial) streams which may increase diversity (e.g., spatial diversity) and the likelihood successful signal reception. Thus, MIMO techniques may use multiple antennas on an AP 105 or multiple antennas on a STA 115 to take advantage of multipath environments to transmit multiple data streams. In some cases, an AP 105 may implement MU-MIMO transmissions in which the AP 105 simultaneously transmits independent data streams to multiple STAs 115. For example, in an MU-N transmission, an AP 105 may simultaneously transmit signals to N STAs. Thus, when an AP 105 has traffic for many STAs 115, the AP 105 may increase network throughput by aggregating individual streams for each STA 115 into a single MU-MIMO transmission. In some cases, an AP 105 may send traffic to a single STA 115 using SU-MIMO.

An AP 105 may use beamforming to focus transmission energy toward a receiving device (e.g., a STA 115). For example, an AP 105 may increase power (e.g., gain) in a certain direction by positioning its antennas so that constructive and destructive interference create a beam of focused energy. An AP 105 may send MU-MIMO transmission using beamforming. In order to generate an appropriate MU-MIMO beam, an AP 105 may first determine the characteristics of the channel over which the MU-MIMO transmissions are to be sent (e.g., the AP 105 may perform channel calibration). For instance, the AP 105 may use channel information from channel measurements to send N spatially-focused MU-MIMO streams to N STAs 115. To determine channel characteristics, an AP 105 may perform a channel calibration procedure which may be referred to herein as sounding or packet sounding. To implement sounding, the AP 105 may poll STAs 115 for channel state information (CSI) by sending null data packets (NDPs) to the STAs 115. The NDPs may be sent over the channel which the AP 105 desires information. One or more NDPs may be sent to a STA 115. For example, the AP 105 may send multiple NDPs to a STA 115 for MU transmissions. In some cases, a channel estimation error of up to −25 dBc may be needed for robust beamforming.

The STAs 115 may analyze the received NPD(s) to determine channel characteristics. For example, the STAs 115 may process each subcarrier used to convey an NDP and generate a channel characteristic report that describes the performance of the subcarrier between the AP 105 and the STA 115. The channel characteristics may be based on the received power and phase shifts of the NDP signal. In some cases, the channel characteristics may include CSI that includes interference information for NDP packets. In some cases the interference information in the CSI may include a signal-to-interference-plus-noise ratio (SINR). The SINR may be a wideband SINR determined as the ratio of narrowband signal to wideband noise and interference (e.g., the noise and interference measured across the bandwidth of the signal). In some cases, the CSI may include interference information as a signal-to-noise ratio (SNR) for the NDP packets (or other signals received by the STA 115). Each STA 115 that receives an NDP may respond to the NDP by sending a corresponding channel characteristic report to the AP 105.

The AP 105 may use the channel characteristics included in the channel characteristic report to generate transmissions (e.g., MIMO transmissions) that radiate energy in a preferred direction. MIMO transmissions that are generated using the channel characteristic information (e.g., CSI) may be referred to as closed-loop MIMO transmissions. MIMO transmissions that are generated without using the channel characteristic information may be referred to as open-loop MIMO transmissions. Closed-loop MIMO transmissions may be more robust than open-loop MIMO transmissions when the CSI is uncorrupted. However, an AP 105 may use open-loop MIMO transmissions when the corruption of the CSI is unknown or severe. Thus, the AP 105 may avoid using corrupted channel characteristic information when generating MIMO transmissions, which may increase reliability.

AP 105 may operate according to a RAT, such as Wi-Fi technology. The coverage area 110 may overlap with the coverage area of another service-providing device such as a base station (not shown). The base station may operate according to a different RAT than AP 105. For example, the base station may provide service to STAs 115 using LTE technology. Thus, wireless communication system 100 may be part of a heterogeneous communications network that includes devices (e.g., APs and base stations) that operate according to different RATs. In some cases, communications associated with different RATs may be communicated over the same frequency spectrum. For example, a first RAT (e.g., Wi-Fi) may use the same unlicensed radio frequency channel as a second RAT (e.g., LTE). The unlicensed radio frequency channel may be included in (e.g., be a portion of) an unlicensed radio frequency spectrum band. The unlicensed radio frequency spectrum band may include a portion or all of the system bandwidth used by an AP 105. In some cases, one of the RATs (or multiple RATs) may implement a channel access scheme that ensures fair use of the unlicensed (e.g., shared) radio frequency channel. For example, the channel access scheme may restrict a RAT from monopolizing or dominating the unlicensed channel. Such an access scheme may promote coexistence between various RATs in a heterogeneous communications network.

In one example, a device using the second RAT (e.g., LTE technology) may facilitate fair sharing of a radio frequency spectrum band (e.g., an unlicensed radio frequency spectrum band) by sensing congestion over a channel (e.g., an unlicensed channel) included in the radio frequency spectrum band and adjusting transmissions accordingly. For instance, a base station may implement carrier-sensing adaptive transmission (CSAT) in which the base station senses a channel for a period of time to determine the activity of other RATs using the channel. Based on the activity level, the base station may reserve a period of time for use (e.g., an active period) and a period of time restricted from use (e.g., an inactive period). Thus, the active period may indicate a duration of time the base station is permitted to access the channel and the inactive period of time may indicate a duration of time the base station is not permitted to access the channel. The active period may be short when activity from other RATs on the channel is high and longer when the activity from other RATS on the channel is low. The combination of the active period and the inactive period may be referred to as a CSAT pattern. A CSAT pattern may be an example of a communication pattern. A CSAT pattern may be fixed or modified dynamically (e.g., by the base station) to adjust to changing conditions (e.g., activity) on the channel.

In some cases, the communication pattern of a RAT may not be known by other RATs in the heterogeneous communication network. For example, a device associated with a first RAT (e.g., Wi-Fi technology) may be unaware of the communication pattern of a second RAT (e.g., LTE technology) and attempt to communicate (e.g., using a contention-based access protocol, etc.) over the unlicensed channel during the active period of the communication pattern. In such a scenario, the traffic from LTE devices may interfere with or prevent communications of the Wi-Fi devices. Thus, the Wi-Fi devices may implement a communication pattern detection scheme to determine the LTE communication pattern and adjust communications accordingly. The adjustments may mitigate interference caused by the LTE devices.

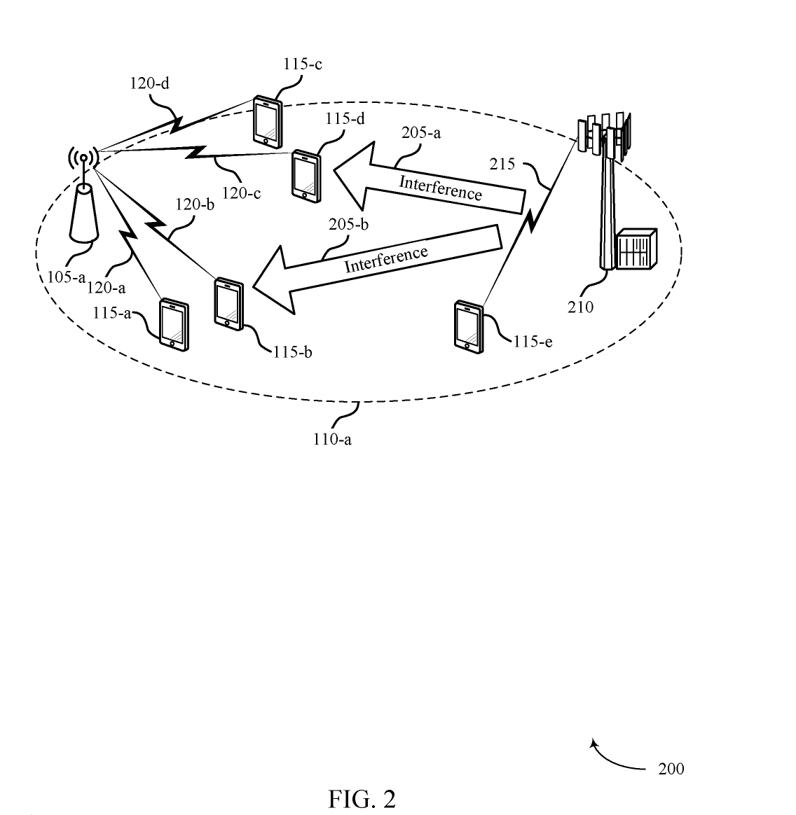

FIG. 2 illustrates an example of a wireless communications subsystem 200 that supports communication pattern detection for unlicensed radio frequency spectrum bands in accordance with aspects of the present disclosure. Wireless communications subsystem 200 may include AP 105-a and STAs 115-a through 115-e. AP 105 and STAs 115-a through 115-e may be examples of an AP 105 and STA 115 described with reference to FIG. 1. AP 105-a may use a first RAT (e.g., Wi-Fi) and may communicate with devices (e.g., STAs 115) within coverage area 110-a. Coverage area 110-a may overlap with the coverage area (not shown) of base station 210. Base station 210 may use a different RAT than AP 105 (e.g., base station 210 may use LTE technology). Thus, wireless communications subsystem 200 may be an example of a heterogeneous network.

Both AP 105-a and base station 210 may communicate over unlicensed radio frequency spectrum. Base station 210 may implement fair-sharing access techniques. For example, base station 210 may transmit according to a communication pattern (e.g., a CSAT pattern). Although described with reference to Wi-Fi and LTE, other RATs may be used in wireless communications subsystem 200 and may support the techniques described herein. Examples of other RATs include, but are not limited to, Universal Terrestrial Radio Access (UTRA), Global System for Mobile communications (GSM), Ultra Mobile Broadband (UMB), Evolved-UTRA (E-UTRA), IEEE 802.16 (Wi-Max), IEEE 802.20, etc.

Base station 210 may communicate with STA 115-e over the communication link 215 using LTE. The communication link 215 may be over an unlicensed channel included in an unlicensed radio frequency spectrum band. LTE communications may occur over the unlicensed channel during active periods of the communication pattern; during inactive periods of the communication pattern, LTE communications may be absent from the unlicensed channel. The active period may also be based on the activity from other RATs on the unlicensed channel.

AP 105-a may communicate with STA 115-a and STA 115-b via communication link 120-a and communication link 120-b, respectively. In some cases, AP 105-a may communicate with STA 115-a and STA 115-b via beam-formed MU-MIMO transmissions (e.g., STA 115-a and STA 115-b may form a MU-MIMO group that receives MU-MIMO communications that include an MU group ID assigned to the MU-MIMO group). AP 105-a may communicate with STA 115-c and STA 115-d via communication link 120-c and communication link 120-d, respectively. In some cases, AP 105-a may communicate with STA 115-c and STA 115-c via beam-formed MU-MIMO transmissions (e.g., STA 115-c and STA 115-d may form a MU-MIMO group that receives MU-MIMO communications that include a MU group ID assigned to the MU-MIMO group). The communication links 120 may be over the unlicensed channel used by base station 210.

In some cases, AP 105-a may attempt to communicate over the unlicensed channel at the same time as base station 210 or STA 115-e (e.g., during the active period of the communication pattern used by base station 210). In such cases, the communications from base station 210 and/or STA 115-e may interfere with or prevent the communications from AP 105-a (e.g., NDPs from AP 105-a may see interference from LTE transmissions associated with base station 210). Thus, LTE transmissions over communication link 215 may cause interference 205-a for Wi-Fi transmissions to STA 115-c and STA 115-d. LTE transmissions over communication link 215 may also cause interference 205-b for Wi-Fi transmissions to STA 115-a and STA 115-b.

AP 105-a may detect the communication pattern used by base station 210 and adjust communications to mitigate interference caused by base station 210. In some cases, AP 105-a may detect the communication pattern by evaluating interference information (e.g. SINR information or SNR information) included in the CSI as an indication of interference. If the SINR is high, AP 105-a may determine that the communication pattern is in the inactive period. If the SINR is low, AP 105-a may determine that the communication pattern is in the active period. Thus, the SINR may reflect the activity of the communication pattern. AP 105-a may determine whether the SINR is high or low by comparing it to one or more thresholds. AP 105-a may continue to evaluate the SINR for the unlicensed channel until the communication pattern is learned. For example, AP 105-a may periodically send NDPs to STAs 115 to determine the activity of the communication pattern during the corresponding transmission times. By leveraging past data points that indicate when the communication pattern was active and when the communication pattern was inactive, AP 105-a may extrapolate the duty cycle of the communication pattern. Thus, AP 105-a may identify the communication pattern using signaling (e.g., channel characteristic reports) received over the unlicensed channel. Although described with reference to SINR, a similar process may be implemented using other channel characteristics, such as SNR.

In another example, AP 105-a may identify the communication pattern by evaluating characteristics of signals that are sent over the unlicensed channel using Wi-Fi. For instance, AP 105-a may measure the power of received signals to determine the active and inactive periods of the communication pattern. AP 105-a may determine a received signal strength indicator (RSSI) for a signal. The RSSI may be a measurement of the power of a signal received by the antennas of AP 105-a. A high RSSI indicates a strong signal; a low RSSI indicates a weak signal. AP 105-a may compare the RSSI to one or more thresholds. If the RSSI is high, AP 105-a may assume that the corresponding signal was sent during the inactive period of the communication pattern. If the RSSI is low, AP 105-a may assume that the corresponding signal was sent during the active period of the communication pattern. By continuing to monitor the RSSI of signals received over the unlicensed channel AP 105-a may obtain sufficient data to detect the active and inactive periods of the communication pattern, thus learning the duty cycle of the communication. In one example, a STA 115 may identify the communication pattern via RSSI analysis and send an indication of the communication pattern to AP 105-a.

In some cases, AP 105-a may identify the communication pattern via signaling from base station 210. For example, base station 210 may indicate the communication pattern in a message sent to AP 105-a. The message may be sent over the unlicensed channel or over a different channel included in the unlicensed radio frequency spectrum band. The message may indicate the active periods and/or inactive periods of the communication pattern. For example, the message may be a clear-to-send-to-self (CTS-to-self) message from base station 210. The CTS-to-self may be sent over the unlicensed channel and may reserve the unlicensed channel for use by base station 210 for a period of time (e.g., an active period).

In another example, AP 105-a may identify the communication pattern by analyzing pilot signals transmitted by base station 210. For example, AP 105-a may receive a primary synchronization signal (PSS), a secondary synchronization signal (SSS), and/or a cell-specific reference signal (CRS) over the unlicensed channel from base station 210. Because base station 210 is not permitted to use the unlicensed channel during the inactive period of the communication pattern, pilot signals are present on the unlicensed channel during the active period. Thus, AP 105-a may determine the active period (and thus the communication pattern) by detecting the presence of pilot signals on the unlicensed channel. In some cases, a STA 115 may determine the communication pattern via reception of pilot signals and send an indication of the communication pattern to AP 105-a. In some scenarios, AP 105-a may identify the communication pattern using signaling from base station 210 and signaling from another device (e.g., a STA 115). For example, AP 105-a may use a combination of information obtained from base station 210 and a STA 115.

In some cases, one set of STAs 115 may experience more interference during the communication pattern active period than another set of STAs 115. For example, STA 115-c and STA 115-d may experience more interference from LTE communications over the unlicensed channel than STA 115-a and STA 115-b (e.g., interference 205-a may be greater than interference 205-b). AP 105-a may detect the severity of the interference impact for each STA 115 or set of STAs 115 (e.g., by probing the channel and evaluating channel characteristics such as SINR). In some examples, each STA 115 may autonomously determine the interference impact for itself and report the severity in a message to AP 105-a. AP 105-a may adjust communications to the STAs 115 based on the severity of the interference impact on the STAs 115. In the present example, after detecting that STA 115-c and STA 115-d are experiencing severe impact from interference 205-a (e.g., interference determined to be above a first predetermined threshold), AP 105-a may schedule communications to STA 115-c and STA 115-d during the inactive period of the communication pattern. After detecting that STA 115-a and STA 115-b are experiencing mild impact from interference 205-b (e.g., interference determined to be below the first predetermined threshold, below a second predetermined threshold, etc.), AP 105-a may communicate with STA 115-a and STA 115 irrespective of the communication pattern (e.g., AP 105-a may schedule transmissions to and/or from STA 115-a and STA 115-b during both the active period and the inactive period of the communication pattern). Thus, AP 105-a may communicate with STAs 115 that are severely impacted by the interference during the inactive period (e.g., those STAs 115 having interference determined to be above a first predetermined threshold) and communicate with STAs 115 that are negligibly impacted by the interference during the active period and/or inactive period (e.g., those STAs 115 having interference determined to be below the first predetermined threshold, below a second predetermined threshold, etc.). The above-described thresholds may also be associated with a time period value over which the threshold may be satisfied, or over which an average, mean, or median value of the interference may be satisfied.

Additionally or alternatively, AP 105-a may adjust the type of transmission to and/or from STAs 115 when interference impact is severe. In the present example, AP 105-a may switch from MU-MIMO communications with STA 115-c and STA 115-d to SU-MIMO communications during the active period of the communication pattern. SU-MIMO communications may be more robust and/or less affected by interference 205-a than MU-MIMO communications. During the inactive period of the communication pattern AP 105-a may switch back to using MU-MIMO communications with STA 115-c and STA 115-d. In some examples, AP 105-a may switch between closed-loop MU-MIMO communications and open-loop MU-MIMO communications (e.g., closed-loop MU-MIMO communications may occur during the inactive period and open-loop MU-MIMO communications may occur during the active period).

In some instances, AP 105-a may select the rate (e.g., by selecting the modulation and coding scheme (MCS)) of a transmission based on the communication pattern. An MCS index may be used to indicate different combinations of modulation type and coding rate. An MCS with a higher index value may indicate a higher data rate (that may indicate a higher transmission reliability or robustness) compared with an MCS with a lower index value (and may also indicate a lower transmission reliability or robustness). Thus, AP 105-a may select a lower MCS for use during the active period of the communication pattern relative to the MCS selected for use during the inactive period.

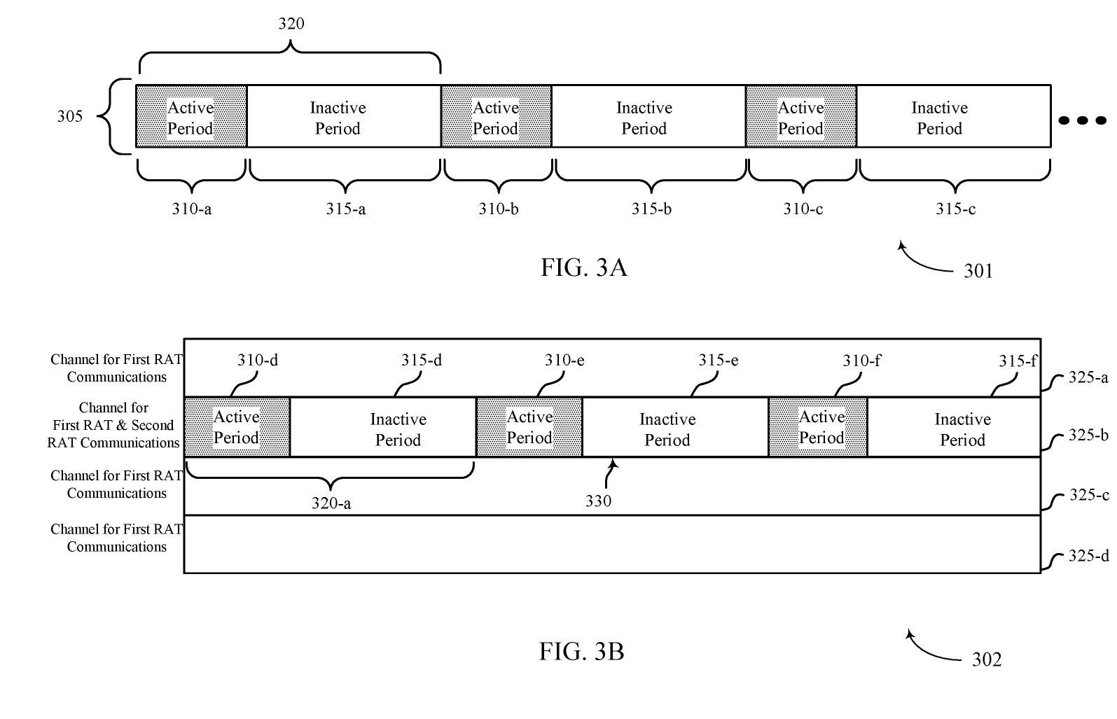

FIG. 3A illustrates an example of a wideband communication pattern 301 that supports communication pattern detection for unlicensed radio frequency spectrum bands in accordance with aspects of the present disclosure. The wideband communication pattern 301 may be an example of a communication pattern used by a device using a second RAT. In some cases, the device may be a base station and the second RAT may be LTE. The wideband communication pattern 301 may be used to ensure fair sharing of an unlicensed channel 305 with a first RAT (e.g., Wi-Fi). The unlicensed channel 305 may be included in an unlicensed frequency spectrum band. The unlicensed channel 305 may represent the total system bandwidth used by the first RAT or a portion of the total system bandwidth used by the first RAT. Wideband communication pattern 301 may be based on the congestion of first RAT traffic over the unlicensed channel 305. Wideband communication pattern 301 may be dynamic (e.g., wideband communication pattern 301 may change corresponding to channel conditions).

Wideband communication pattern 301 may include active periods 310 and inactive periods 315 that occur periodically. Devices using the first RAT may be permitted access to the unlicensed channel 305 during active periods 310 and inactive periods 315. Access to the unlicensed channel 305 may be restricted for devices using the second RAT. For example, during inactive periods 315, devices using the second RAT may be restricted from accessing the unlicensed channel 305. Thus, communications sent using the second RAT may not be present on the unlicensed channel 305 during inactive period 315-a, inactive period 315-b, and inactive period 315-c. During active periods 310, devices using the second RAT may be permitted access to the unlicensed channel 305 (e.g., devices using the second RAT may communicate using the unlicensed channel 305 during active periods 310). Thus, the unlicensed channel 305 may be used to convey second RAT communications during active period 310-a, active period 310-b, and active period 310-c. The wideband communication pattern 301 may have a communication pattern duty cycle period 320. The duty cycle period 320 may include an active period 310 and a corresponding inactive period 315. The duty cycle period 320 may represent the smallest repeatable pattern of the wideband communication pattern 301.

In some cases, communications associated with the first RAT and the second RAT may be present on the unlicensed channel 305 during active periods 310. In such instances, transmissions associated with the second RAT may interfere with transmissions associated with the first RAT. A device using the first RAT (e.g., an AP 105 or a STA 115) may detect the interference and identify the wideband communication pattern 301 (e.g., using the techniques described herein and, e.g., with reference to FIG. 2). The device may modify communications (e.g., by selecting the MCS, transmission time, type of MIMO transmission, sets of STAs to transmit to, a transmission bandwidth, and/or type of transmission) to mitigate deleterious effects caused by the interference. In this or other examples, the device may send an indication of the wideband communication pattern 301 to another device (e.g., a STA 115 may send a message to an AP 105 indicating the wideband communication pattern 301).

FIG. 3B illustrates an example of an unlicensed radio frequency spectrum band 302 that supports communication pattern detection for unlicensed radio frequency spectrum bands in accordance with aspects of the present disclosure. Unlicensed radio frequency spectrum band 302 may be an example of an unlicensed radio frequency spectrum system bandwidth in use by a device using a first RAT (e.g., an AP 105 using Wi-Fi technology). Unlicensed radio frequency spectrum band 302 may include unlicensed channel 325-a, unlicensed channel 325-b, unlicensed channel 325-c, and unlicensed channel 325-d. A device using a second RAT (e.g., a base station using LTE technology) may access unlicensed channel 325-b according to the narrowband communication pattern 330. The narrowband communication pattern 330 may be an example of a communication pattern described with reference to FIGS. 1-3A.

The narrowband communication pattern 330 may have a narrowband duty cycle period 320-a. Devices using the second RAT may be permitted access to unlicensed channel 325-a during active periods 310 of the narrowband communication pattern 330 and may be restricted from accessing unlicensed channel 325-a during inactive periods 315. For example, a device using the second RAT may send or receive transmissions over unlicensed channel 325-a active period 310-d, active period 310-e, and/or active period 310-e. The device may be restricted from sending or receiving transmissions over unlicensed channel 325-a during inactive period 315-d, inactive period 315-e, and inactive period 315-f. In some cases, the device may send a message to one or more devices of the first RAT announcing the narrowband communication pattern 330 (e.g., the device may send a CTS-to-self that is received by one or more devices associated with the first RAT). In other cases, the device may send pilot signals (e.g., PSS, SSS, CRS, etc.) which implicitly indicate (e.g., by their presence on unlicensed channel 325-a) the narrowband communication pattern 330 to one or more devices associated with the first RAT.

A device using the first RAT may detect the narrowband communication pattern 330 via signaling from a device using the second RAT, as described above, or via signaling received from a device using the first RAT. For example, a device using the first RAT may evaluate RSSI or SINR to determine when the active periods 310 and inactive periods 315 occur. In other examples, the device using the first RAT may receive an indication of the narrowband communication pattern 330 from another device using the first RAT (e.g., an AP 105 may receive a message from a STA 115 that indicates the narrowband communication pattern 330). In some instances, a device using a first RAT may identify the communication pattern via a combination of signaling from a device using the first RAT and a device using the second RAT.

Communications associated with the second RAT may interfere with communications associated with the first RAT. The interference may affect a portion of the unlicensed radio frequency spectrum band 302 (e.g., the interference may affect communications conveyed over unlicensed channel 325-a, but not affect communications conveyed over unlicensed channel 325-a, unlicensed channel 325-c, and/or unlicensed channel 325-d). In such cases, a device using the first RAT may detect the portion of the system bandwidth that is affected (e.g., unlicensed channel 325-b). For example, a device associated with the first RAT may evaluate a narrowband SINR corresponding to the affected portion of the system bandwidth. A narrowband SINR may represent the signal-to-noise-plus-interference ratio of a signal sent over a narrowband portion of the system bandwidth. The narrowband SINR may be determined as the ratio of narrowband signal to narrowband noise and interference. The narrowband SINR may be computed for various ranges of the unlicensed radio frequency spectrum band 302 (e.g., the narrowband SINR may be computed for a 20 MHz channel that is included in a 160 MHZ system bandwidth, or a 40 MHz channel that is included in a 240 MHz system bandwidth, etc.). Thus, a device associated with a first RAT may identify a narrowband communication pattern of a device associated with a second RAT.

Narrowband SINR may be computed by a STA 115. A STA 115 may advertise its ability to support narrowband SINR by sending a message indicating narrowband capability to an AP 105. For instance, a STA 115 may signal narrowband capabilities via vendor-specific information elements (e.g., management frames) during or after association. An AP 105 may request for a STA 115 to send a narrowband SINR report (e.g., by setting a bit included in an NDP sent to the STA 115). In other cases, the STA 115 may autonomously determine the narrowband SINR and send the narrowband SINR to the AP 105. Based on the narrowband SINR, an AP 105 may identify the narrowband communication pattern 330 and adjust communications accordingly.

For example, the device using the first RAT may selectively schedule communications for sets of STAs 115 based on the narrowband communication pattern 330. In one example, the device using the first RAT may schedule communications (e.g., for a first set of STAs 115 impacted by the narrowband communication pattern 330) on channels unassociated with the communication pattern to occur during the active period of the narrowband communication pattern 330. For instance, the device may schedule communications over unlicensed channel 325-a, unlicensed channel 325-c, and unlicensed channel 325-d during active period 310-d, active period 310-e, and active period 310-f Thus, the device may refrain from transmitting to selected STAs 115 over unlicensed channel 325-b during active periods of the narrowband communication pattern 330.

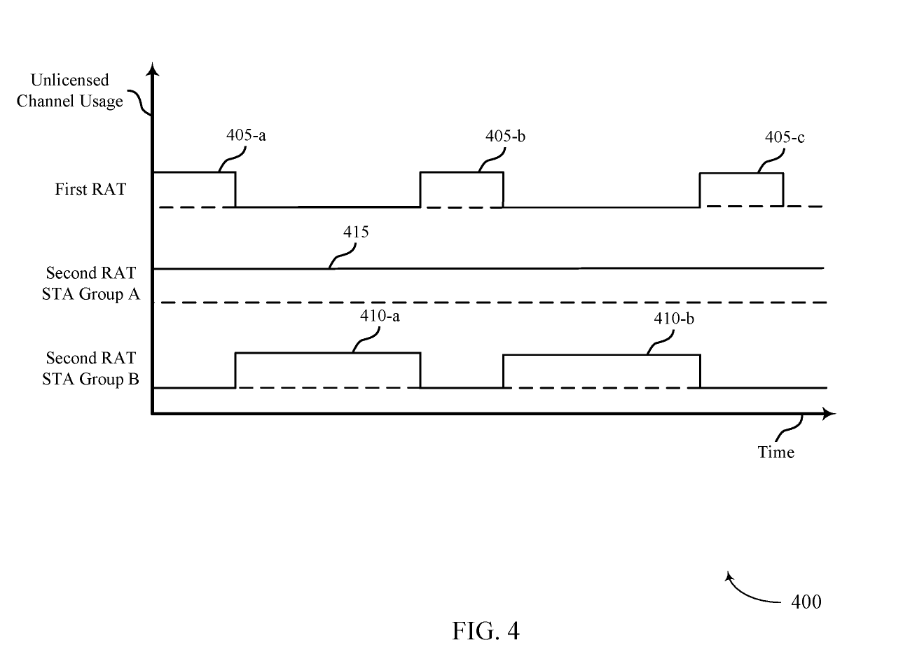

FIG. 4 illustrates an example of a communications timing diagram 400 that supports communication pattern detection for unlicensed radio frequency spectrum bands in accordance with aspects of the present disclosure. Communications timing diagram 400 may be an example of heterogeneous transmissions over an unlicensed channel. The unlicensed channel may be convey transmissions associated with a first RAT (e.g., Wi-Fi) and transmissions associated with a second RAT (e.g., LTE). The second RAT may access the unlicensed channel according to a communication pattern, such as the communication pattern described with reference to FIGS. 1-3B. The first RAT may have unrestricted access attempts (e.g., according to a contention-based access protocol) to the unlicensed channel, such as described with reference to FIGS. 1-3B. Communications using the first RAT may include transmissions to and/or from a first set of STAs 115 (e.g., first RAT STA group A) and a second set of STAs 115 (e.g., first RAT STA group B). In an example, each set of STAs 115 may be included in a MU-MIMO group.

The second RAT may communicate over the unlicensed channel during active periods 405 of the communication pattern. Thus, the second RAT may communicate on the unlicensed channel during active period 405-a, during active period 405-b, and during active period 405-c. Thus, use of the unlicensed channel by the second RAT may occur during active period 405-a, during active period 405-b, and during active period 405-c. Durations of time in which the second RAT does not use the unlicensed channel may represent inactive periods of the communication pattern. A device associated with the first RAT (e.g., an AP 105) may identify the communication pattern and coordinate second RAT communications based on the communication pattern. In some cases, the AP 105 may determine that STA group B is more affected by the second RAT communications (e.g., via interference) than STA group B. In such an instance, the AP 105 may schedule communications for STA group B during the inactive periods of the communication pattern. Thus, STA group B may use the unlicensed channel for communication during communications interval 410-a and during communications interval 410-b. The communications intervals 410 may coincide with the inactive periods of the communication pattern. Thus, the AP 105 may delay first RAT transmissions based on the severity of the interference affects cause by the second RAT communications. In some cases, the STA groups are from different service sets (e.g., overlapping basic service sets (OBSSs)). Thus, STAs 115 from the overlapping OBSSs can see different levels of interference.

Because STA group A is less affected by the second RAT communications, the AP 105 may schedule STA group A during the active and inactive periods of the communication pattern (e.g., channel usage associated with STA group A may occur during interval 415). Thus, the AP 105 may increase the amount of time STA group A has access to the unlicensed channel. In some cases, the AP 105 may schedule STA group A for communication during the active periods and not during the inactive periods. Thus, devices may transmit over the unlicensed channel during active periods of the unlicensed channel. In some cases, the unlicensed channel is a portion of the system bandwidth used by the first RAT. In other cases, the unlicensed channel includes the system bandwidth used by the first RAT.

The AP 105 may additionally or alternatively adjust the MCS used for communications associated with STA group A and/or STA group B. For example, the AP 105 may use a high MCS for STA group A and STA group B during inactive periods of the communication pattern. During active periods of the communication pattern, the AP 105 may use a lower MCS for STA group B. In some cases, the AP 105 may adjust the type of communications that are sent over the unlicensed channel based on the communication pattern. For example, the AP 105 may send MU-MIMO (or closed-loop MIMO) transmissions to STA group A during the inactive periods of the communication pattern and send SU-MIMO (or open-loop MIMO) transmissions to STA group A during the active periods of the communication pattern.

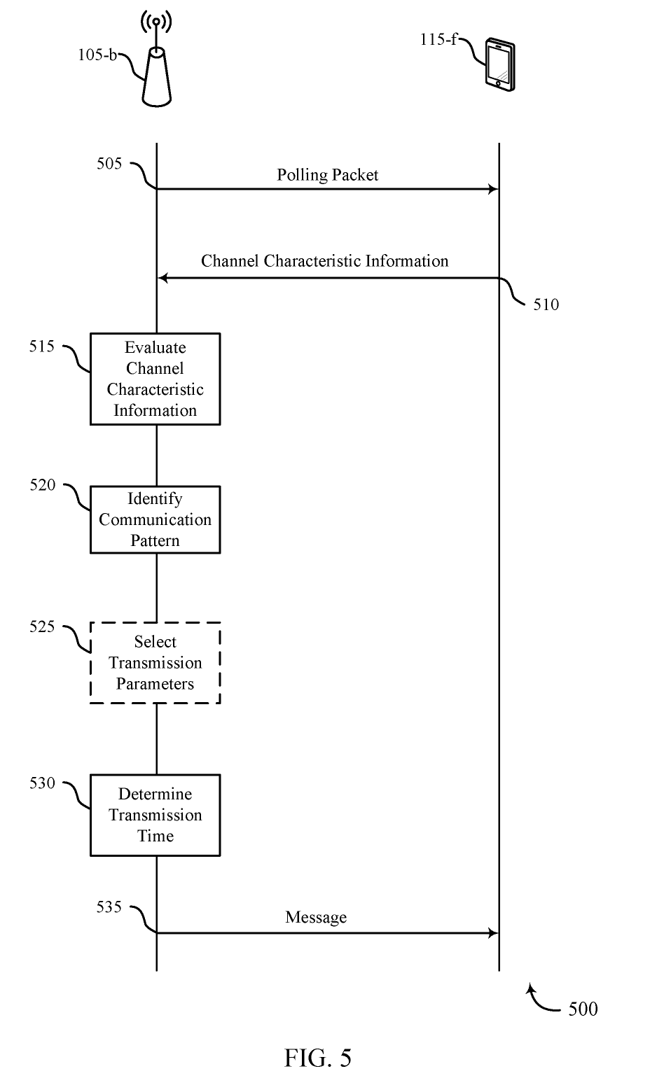

FIG. 5 illustrates an example of a process flow 500 in a system that supports communication pattern detection for unlicensed radio frequency spectrum bands in accordance with aspects of the present disclosure. Process flow 500 may be performed by two devices (e.g., AP 105 and STA 115-f) using a first RAT (e.g., Wi-Fi) over an unlicensed channel. AP 105-b and STA 115-f may be examples of an AP 105 and STA 115 described with reference to FIGS. 1-4. The unlicensed channel may be accessed by devices using a second RAT (e.g., LTE) according to a communication pattern (e.g., a CSAT pattern). Although described with reference to Wi-Fi and LTE, the techniques described herein may be implemented by devices using various RATs or a combination of RATs.

At 505, AP 105-b may transmit a polling packet (e.g., an NDP) to STA 115-f. STA 115-f may evaluate the polling packet to determine channel characteristics and, at 510, send channel characteristic information to AP 105-b. For example, STA 115-f may send CSI to AP 105-b. The CSI may include wideband or narrowband SINR. In some cases, the CSI may include an indication of RSSI associated with the polling packet. At 515, AP 105-b may evaluate the channel characteristic information. In some cases, evaluating the channel characteristic information includes comparing the SINR or RSSI to one or more thresholds, which thresholds may be predetermined. Thus, AP 105-a may determine whether the SINR or RSSI is a high value or a low value.

At 520, AP 105-b may identify the communication pattern used by the second RAT. The identification may be based at least in part on the channel characteristic information. For instance, if the SINR value is low, then AP 105-b may determine that the polling packet was sent during an active period of the communication pattern. Alternatively, if the SINR value is high, AP 105-b may determine that the polling packet was sent during an inactive period of the communication pattern. In another example, AP 105-b may determine that the polling packet was sent during the active period of the communication pattern if the RSSI associated with the polling packet is low. Conversely, AP 105-b may determine that the polling packet was sent during an inactive period of the communication pattern. In some cases, the RSSI may correspond to the channel characteristic information message sent at 510 (e.g., AP 105-b may compute the RSSI for the signal conveying the channel characteristic information). Thus, AP 105-b may identify the communication pattern based at least in part on signaling received by AP 105-b.

At 525, AP 105-b may determine a transmission time for attempting to transmit over the unlicensed channel. The transmission time may be determined based at least in part on the identified communication pattern. The transmission may be for STA 115-f or a different STA 115. In some cases, the transmission time may be delayed (e.g., the transmission time may be delayed until an inactive period of the communication pattern). In some cases, the transmission time may be selected to be during an active period of the communication pattern. The selection of the transmission time may be based on the severity of the interference experienced at the target STA 115 due to communications on the unlicensed channel by the second RAT. In some examples, AP 105-b may also select or modify an MCS to be used for the transmission. The MCS may be selected based on the communication pattern. For example, a high MCS may be used for the transmission if the transmission time coincides or overlaps with an inactive period of the communication pattern and a low MCS may be used if the transmission time coincides with an active period of the communication pattern. Additionally or alternatively, AP 105-b may select or modify the type of transmission based on the communication pattern. For example, AP 105-b may select a SU-MIMO transmission type if the transmission time coincides with an active period of the communication pattern. AP 105-b may select a MU-MIMO transmission type if the transmission time coincides with an inactive period of the communication pattern. At 535, AP 105-b may send a message to STA 115-f according to the transmission parameters determined at 530.

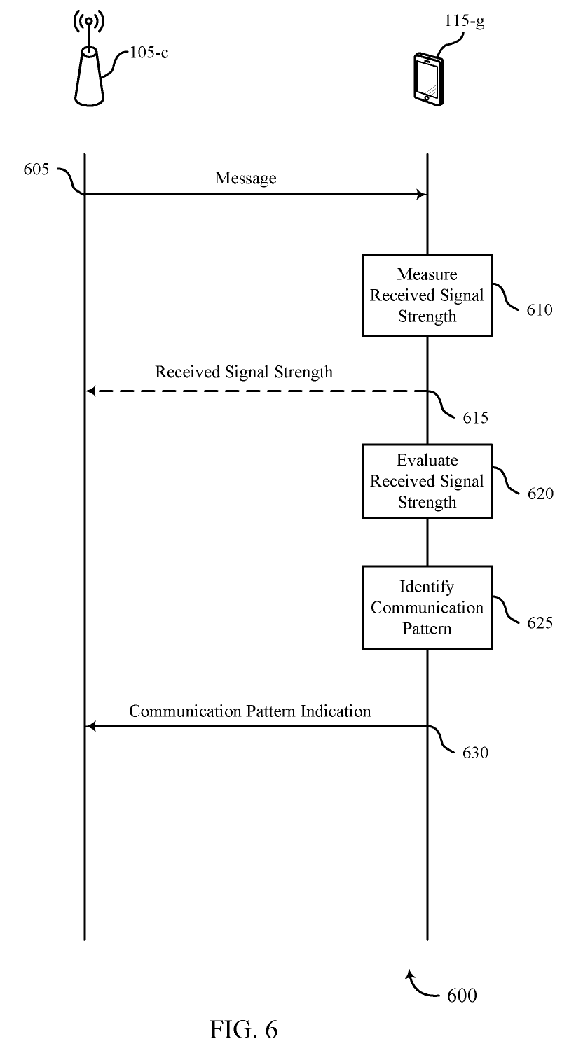

FIG. 6 illustrates an example of a process flow 600 that supports communication pattern detection for unlicensed radio frequency spectrum bands in accordance with aspects of the present disclosure. Process flow 600 may be performed by two devices (e.g., STA 115-g and AP 105-c) using a first RAT (e.g., Wi-Fi). STA 115-g and AP 105-c may be examples of a STA 115 and an AP 105 described with reference to FIGS. 1-5. STA 115-g and AP 105-c may communicate over the air using an unlicensed channel. The unlicensed channel may be included in an unlicensed frequency spectrum band and may include all or a portion of the bandwidth used by AP 105. Devices using a second RAT (e.g., LTE) may access the unlicensed channel according to a communication pattern (e.g., a CSAT pattern), such as those described above with reference to FIGS. 1-5.

At 605, AP 105-c may transmit, and STA 115-g may receive, a message. The message may be conveyed in a signal sent over the unlicensed channel. The message may include control information and/or data intended for STA 115-g. In some cases, the message is a polling packet (e.g., an NDP). Polling packets may be sent periodically. At 610, STA 115-g may measure the received signal strength of the signal used to convey the message. In some cases, STA 115-g may compute the RSSI of the signal. In some cases, STA 115-g may transmit an indication of the received signal strength (e.g., the RSSI) to AP 105-c at 615. In other cases, STA 115-g may, at 620, evaluate the received signal strength (e.g., the RSSI). For example, STA 115-g may compare the received signal strength to one or more thresholds. Based on the evaluation of the received signal strength, STA 115-c may, at 625, identify the communication pattern. For example, STA 115-c may determine that the message was sent during an active period of the communication pattern if the corresponding received signal strength is low (e.g., if the received signal strength does not satisfy or is below a first threshold). Alternatively, STA 115-c may determine that the message was sent during an inactive period of the communication pattern if the corresponding received signal strength is high (e.g., if the received signal strength satisfies or is above a second threshold, which may be the same or different than the first threshold). Thus, STA 115-c may identify the communication pattern based on signaling received by STA 115-c.

At 630, STA 115-g may send an indication of the communication pattern to AP 105-c. The indication may be sent based on the communication pattern. For example, STA 115-g may schedule the message carrying the indication of the communication pattern to occur during an inactive period of the communication pattern. Thus, STA 115-g may determine, based at least in part on the communication pattern, a time period for attempting to transmit the communication indication.

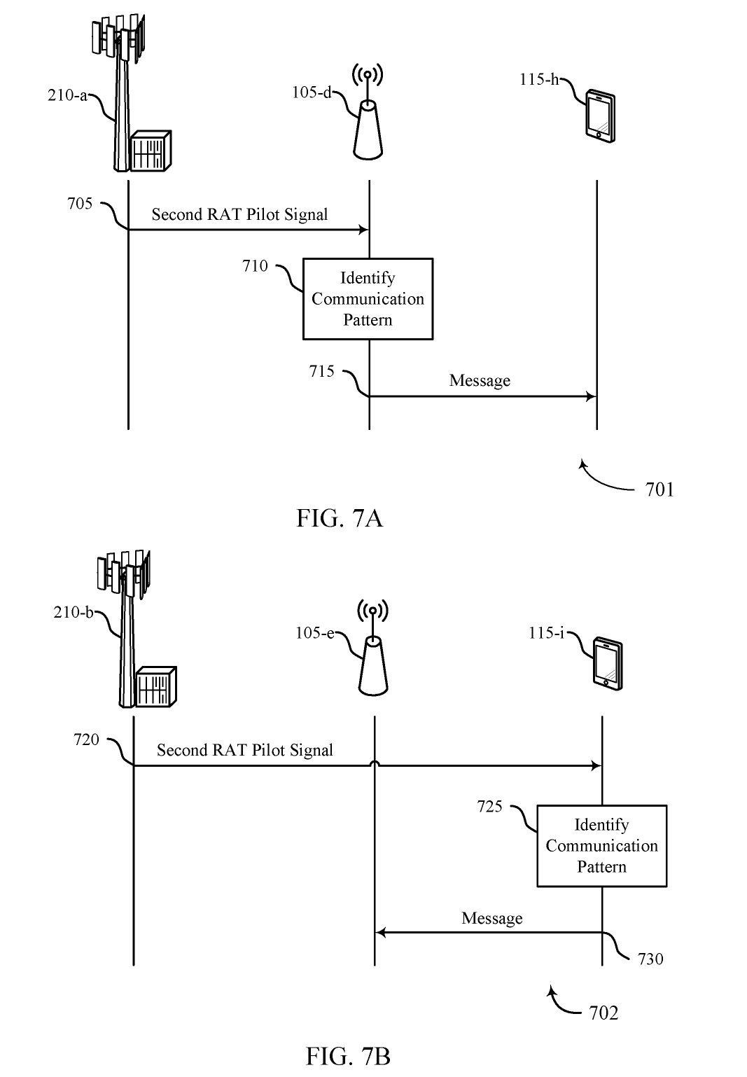

FIG. 7A illustrates an example of a process flow 701 in a system that supports communication pattern detection for unlicensed radio frequency spectrum bands in accordance with aspects of the present disclosure. Process flow 701 may be performed by devices (e.g., base station 210-a, STA 115-h, and AP 105-d) operating in a heterogeneous communications system. STA 115-h and AP 105-d may use a first RAT (e.g., Wi-Fi) and may have contention-based access to an unlicensed channel that is included in an unlicensed radio frequency spectrum band. Base station 210-a may use a second RAT (e.g., LTE) and may have access to the unlicensed channel according to a communication pattern (e.g., a CSAT pattern, or another periodic communication pattern).

At 705 base station 210-a may transmit, and AP 105-d may receive, a pilot signal associated with the second RAT over the unlicensed channel. The pilot signal may be a WWAN pilot signal (e.g., including PSS, SSS, and/or CRS). The pilot signal may be sent according to the communication pattern (e.g., the pilot signal may be transmitted during an active period of the communication pattern). At 710, AP 105-d may identify the communication pattern. The identification may be based on the reception of the pilot signal. For example, AP 105-d may determine that the communication pattern was in an active period when the pilot signal was sent. Thus, AP 105-d may identify the communication pattern by detecting the presence of pilot signals associated with the second RAT over the unlicensed channel. In some cases, base station 210-a may transmit an explicit indication of the communication pattern to AP 105-c. For example, base station 210-a may send a CTS-to-self packet that is received by AP 105-c. AP 105-c may identify the communication pattern using the explicit indication, or a combination of explicit indication and at least another technique described herein.

At 715, AP 105-d may transmit a message to STA 115-h. The message may include data and or control information. The message may be sent based on the identified communication pattern. For example, the message may be sent during a time period that coincides with an inactive period of the communication pattern. In some cases, the MCS of the message may be selected based on the communication pattern. For example, the message may be sent using a low MCS if the transmission time overlaps with an active period of the communication pattern. The message may be sent using a first MCS (e.g., a higher MCS than a second, lower MCS) if the transmission time overlaps with an inactive period of the communication pattern. In some cases, the transmission type of the message may be based on the communication pattern. For example, the message may be part of a MU-MIMO transmission if the transmission time is during an inactive period of the communication pattern. Alternatively, the message may be a SU-MIMO transmission if the transmission time is during an active period of the communication pattern. Thus, transmission parameters may be selected for a transmission based at least in part on the identified communication pattern.

FIG. 7B illustrates an example of a process flow 702 that supports communication pattern detection for unlicensed radio frequency spectrum bands in accordance with aspects of the present disclosure. Process flow 702 may be performed by devices (e.g., base station 210-b, STA 115-I, and AP 105-e) operating in a heterogeneous communications system. STA 115-h and AP 105-d may use a first RAT (e.g., Wi-Fi) and may have contention-based access to an unlicensed channel that is included in an unlicensed radio frequency spectrum band. Base station 210-a may use a second RAT (e.g., LTE) and may have access to the unlicensed channel according to a communication pattern (e.g., a CSAT pattern, or another periodic communication pattern).

At 720, base station 210-b may transmit, and STA 115-i may receive, a pilot signal associated with the second RAT over the unlicensed channel. The pilot signal may be a WWAN pilot signal such as WWAN PSS, a WWAN SSS, or a WWAN CRS associated with the second RAT. The pilot signal may be sent during an active period of the communication pattern. At 725, STA 115-i may identify the communication pattern. The identification may be based on the reception of the pilot signal at 720. For example, STA 115-i may determine that WWAN signaling is present on the unlicensed channel due to the reception of the WWAN pilot signal. Thus, STA 115-i may identify the communication pattern based on signaling received at STA 115-i. At 730, STA 115-i may send a message to AP 105-e. The message may sent according to the identified communication pattern (e.g., the message may be scheduled for a transmission time that coincides with an inactive period of the communication pattern). The parameters of the message (e.g., transmission type, MCS, etc.) may also be based on the communication pattern. In some cases, the message includes an indication of the communication pattern (e.g., an explicit indication in a CTS-to-self packet).

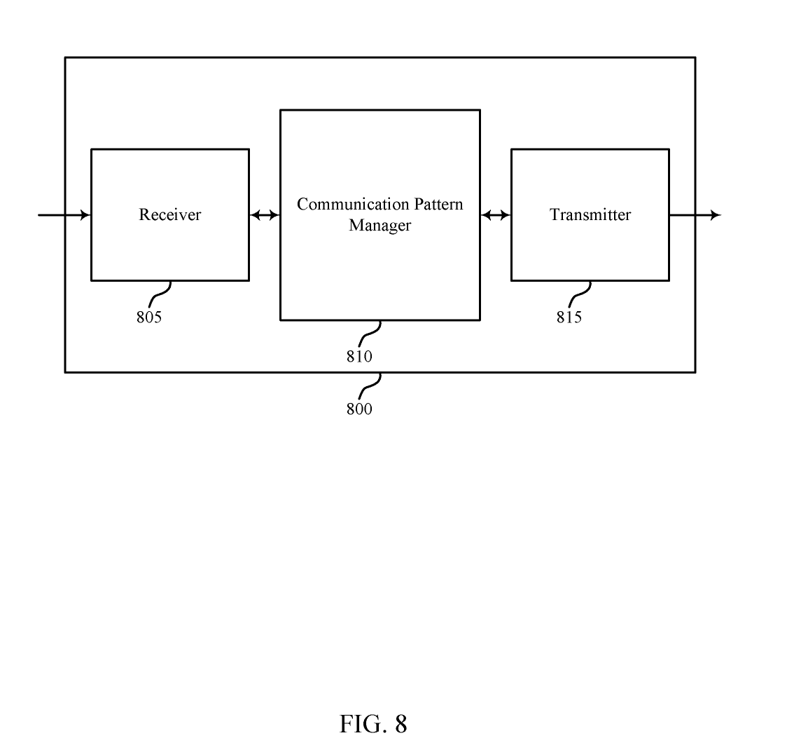

FIG. 8 shows a block diagram of a device 800 that supports communication pattern detection for unlicensed radio frequency spectrum bands in accordance with various aspects of the present disclosure. Device 800 may be an example of aspects of a STA 115 or AP 105 described with reference to FIGS. 1-7B. Device 800 may be part of a heterogeneous network and may communicate over an unlicensed channel using a first RAT (e.g., Wi-Fi). The heterogeneous network may include one or more devices that use a second RAT (e.g., LTE). These devices may access the unlicensed channel according to a communication pattern (e.g., a CSAT pattern). Device 800 may include receiver 805, communication pattern manager 810 and transmitter 815. Device 800 may also include one or more processors, memory coupled with the one or more processors, and instructions stored in the memory that are executable by the one or more processors to enable the one or more processors to perform the communication pattern detection features discussed herein. Each of these components may be in communication with each other.

The receiver 805 may receive information such as packets, user data, or control information associated with various information channels (e.g., control channels, data channels, and information related to communication pattern detection for unlicensed radio frequency spectrum bands, etc.). The receiver 805 may be used to receive signals over unlicensed radio frequency spectrum band that includes the unlicensed channel. In some cases the receiver 805 may receive signals over the unlicensed channel that are from devices using the first RAT. For example, the receiver 805 may receive a channel characteristic report (e.g., CSI) from a STA 115. In some cases, the receiver 805 may receive signals over the unlicensed channel that are from devices using the second RAT. For example, the receiver 805 may receive a CTS-to-self sent over the unlicensed channel from a base station. In another example, the receiver 805 may receive WWAN pilot signals (e.g., WWAN PSS, SSS, and/or CRS) over the unlicensed channel. In some cases, the receiver 805 may receive a message indicating the communication pattern. The receiver 805 may collaborate with other components of device 800 to facilitate the techniques described herein. For example, information may be passed from the receiver 805 to other components (e.g., the communication pattern manager 810) of the device 800.

The communication pattern manager 810 may identify a communication pattern for a transmission using the second RAT over an unlicensed radio frequency spectrum band (e.g., an unlicensed channel). The identification may be based at least in part on signaling received by the device 800. The communication pattern manager 810 may determine, based at least in part on the communication pattern, a time period for attempting to transmit over the unlicensed radio frequency spectrum band (e.g., over the unlicensed channel) using the first RAT. The communication pattern manager 810 may collaborate with other components of the device 800 to facilitate the techniques described herein. In some cases, the communication pattern manager may be a processor. The processor may be coupled with memory and execute instructions stored in the memory that enable the processor to perform or facilitate the communication pattern detection and mitigation features discussed herein.

The transmitter 815 may transmit signals received from other components of device 800. The transmitter 815 may send the signals over the unlicensed radio frequency spectrum band (e.g., the unlicensed channel). For example, the transmitter 815 may send polling packets (e.g., NDPs) over the unlicensed channel. The transmitter 815 may facilitate the transmission of signals using MIMO techniques including closed-loop MIMO, open-loop MIMO, MU-MIMO, SU-MIMO, or a combination thereof. In some cases, the transmitter 815 may facilitate the transmission of a message that indicates the communication pattern. In some examples, the transmitter 815 may be collocated with a receiver in a transceiver module. The transmitter 815 may include a single antenna, or it may include a plurality of antennas.

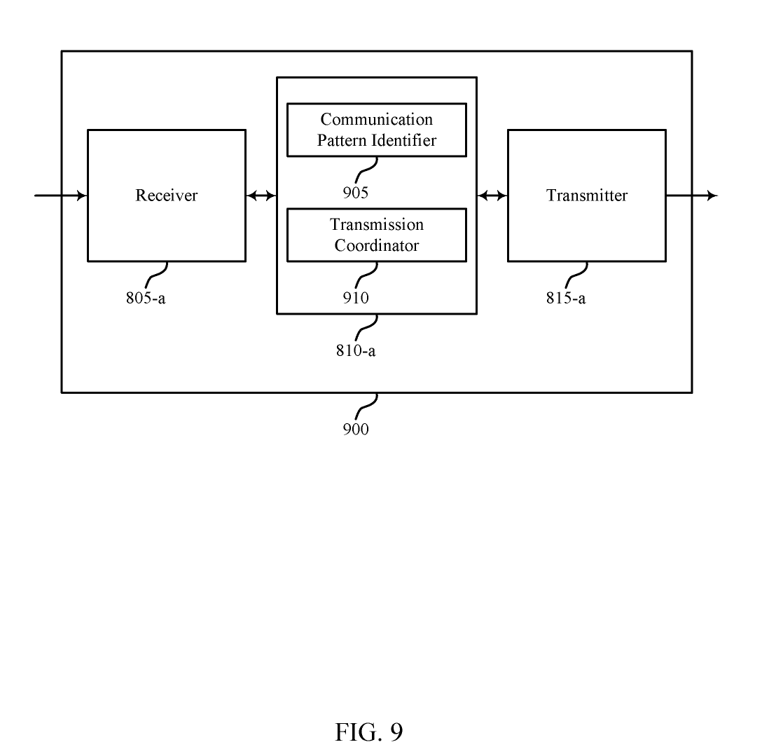

FIG. 9 shows a block diagram of a device 900 that supports communication pattern detection for unlicensed radio frequency spectrum bands in accordance with various aspects of the present disclosure. Device 900 may be an example of aspects of a device 800 or a STA 115 or AP 105 described with reference to FIGS. 1-8. Device 900 may include receiver 805-a, communication pattern manager 810-a and transmitter 815-a. Device 900 may also include a processor. Communication pattern manager 810-a may be an example of aspects of communication pattern manager 810 described with reference to FIG. 8. The communication pattern manager 810-a may include communication pattern identifier 905 and transmission coordinator 910. Each of the components included in device 900 may be in communication with each other.

Device 900 may communicate with other devices over an unlicensed channel (e.g., a channel included in an unlicensed radio frequency spectrum band) using a first RAT. The unlicensed channel may be accessed periodically by one or more devices using a second RAT. The periodicity of the access may be determined by a communication pattern (e.g., a CSAT pattern). In some examples, the communication pattern may include a cyclical or periodic active period of time that WWAN signaling is present on the unlicensed radio frequency spectrum band (e.g., unlicensed channel) and a cyclical or periodic inactive period of time that WWAN is not present on the unlicensed radio frequency spectrum band. In some cases, the first RAT is Wi-Fi technology. In some cases, the RAT is Long Term Evolution technology.

Receiver 805-a may receive information (e.g., over the unlicensed radio frequency spectrum band) which may be passed on to other components of the device. Receiver 805-a may also perform the functions described with reference to the receiver 805 of FIG. 8. Transmitter 815-a may transmit (e.g., over the unlicensed radio frequency spectrum) signals received from other components of device 900. In some examples, transmitter 815-a may be collocated with a receiver in a transceiver module. The transmitter 815-a may utilize a single antenna, or it may utilize a plurality of antennas.

The communication pattern identifier 905 may evaluate signals received over the unlicensed channel and determine the communication pattern used for the unlicensed channel. For example, the communication pattern identifier 905 may identify the communication pattern based at least in part on signaling received by the device 900. In some cases, identifying the communication pattern includes detecting a WWAN pilot signal (e.g., a WWAN PSS, a WWAN SSS, and/or a WWAN CRS) sent over the unlicensed channel. In some examples, the communication pattern identifier 905 may determine that the communication pattern affects a first portion of bandwidth used by the device 900. In some cases, the communication pattern may affect the first portion of the bandwidth more than a second portion of the bandwidth. The bandwidth may be part of the unlicensed spectrum band and may include the unlicensed channel.

The transmission coordinator 910 may facilitate transmissions over the unlicensed radio frequency spectrum band. For example, the transmission coordinator 910 may determine, based at least in part on the communication pattern, a time period for attempting to transmit by the device 900 over the unlicensed radio frequency spectrum band using the first RAT. In some cases, the transmission coordinator 910 may facilitate the transmission of a signal over the first portion of bandwidth during an active period of the communication pattern. The transmission coordinator 910 may delay a transmission over the second portion of bandwidth to during the inactive period. In some cases, the transmission coordinator may select transmission parameters for signals to be sent over the unlicensed radio frequency spectrum. For example, the transmission coordinator 910 may select a first MCS for the device 900 to use for a transmission occurring during an active period of the communication pattern. The first MCS may be lower than a second MCS that is used to transmit during an inactive period of the communication pattern.

In some cases, (e.g., when the device 900 is a STA 115) the transmission coordinator 910 may facilitate the transmission of an indication of the determined communication pattern to a WLAN AP. In other cases (e.g., when the device 900 is a WLAN AP), the transmission coordinator 910 may facilitate MIMO transmissions over the unlicensed radio frequency spectrum. For example, the transmission coordinator 910 may facilitate a SU-MIMO transmission during an active period of the communication pattern. The transmission coordinator 910 may facilitate a MU-MIMO transmission during an inactive period of the communication pattern. In some cases, the device 900 may determine that a first set of STAs 115 is more affected by the communication pattern than a second set of STAs 115. In such cases, the transmission coordinator 910 may facilitate a transmission to the second set of STAs 115 during an active period of the communication pattern and delay a transmission to the first set of STAs 115 until the inactive period.

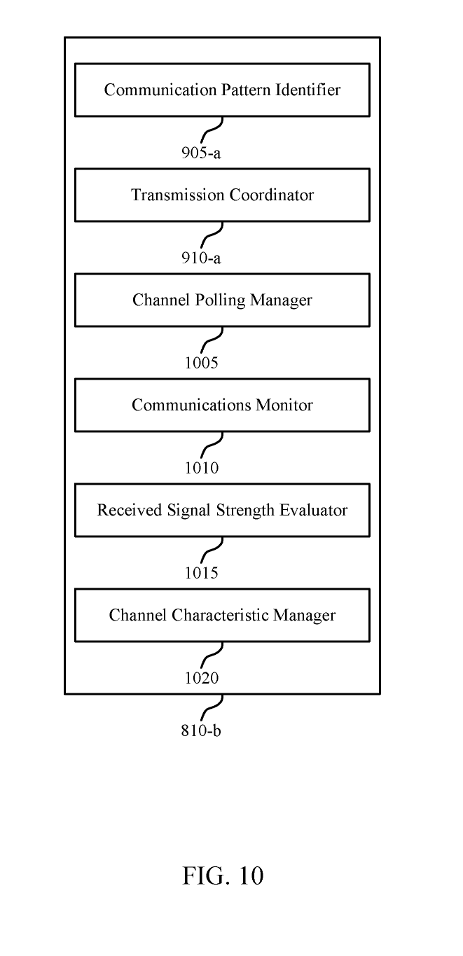

FIG. 10 shows a block diagram of a communication pattern manager 810-b that supports communication pattern detection for unlicensed radio frequency spectrum bands in accordance with aspects of the present disclosure. Communication pattern manager 810-b may be an example of the corresponding component of device 800 or device 900. That is, communication pattern manager 810-b may be an example of aspects of communication pattern manager 810 or communication pattern manager 810-a described with reference to FIGS. 8 and 9. The communication pattern manager 810-a may be included in a device that operates according to a first RAT (e.g., Wi-Fi). The device may communicate with other devices using an unlicensed radio frequency spectrum band (e.g., using an unlicensed channel). The unlicensed radio frequency spectrum band may be accessed according to a communication pattern by other device using a second RAT. The communication pattern may include a cyclical active period of time that WWAN signaling is present on the unlicensed radio frequency spectrum band and a cyclical inactive period of time that WWAN signaling is not present on the unlicensed radio frequency spectrum band.

The communication pattern manager 810-b may include communication pattern identifier 905-a, transmission coordinator 910-a, a channel polling manager 1005, a communications monitor 1010, a received signal strength evaluator 1015, and a channel characteristic manager 1020. Each of these modules may communicate, directly or indirectly, with one another (e.g., via one or more buses).

The communication pattern identifier 905-a may determine whether WWAN signaling is present on the unlicensed radio frequency spectrum band. The determination may be based at least in part on a comparison of RSSI and a threshold. In some cases, communication pattern identifier may identify the communication pattern by detecting a WWAN pilot signal sent over the unlicensed radio frequency spectrum band. The WWAN signal may be a WWAN PSS, a WWAN SSS, a WWAN CRS, or a combination thereof. Thus, communication pattern identifier 905-a may identify the communication pattern for a transmission using a second RAT over the unlicensed radio frequency spectrum band based at least in part on signaling received by the device. In some cases, the communication pattern identifier 905-a may be a processor (e.g., a transceiver processor, or a radio processor, or a receiver processor). The processor may be coupled with memory and execute instructions stored in the memory that enable the processor to perform or facilitate the communication pattern identification features discussed herein. A transceiver processor may be collocated with and/or communicate with (e.g., direct the operations of) a transceiver of the device. A radio processor may be collocated with and/or communicate with (e.g., direct the operations of) a radio (e.g., an LTE radio or a Wi-Fi radio) of the device. A receiver processor may be collocated with and/or communicate with (e.g., direct the operations of) a receiver of the device.

Transmission coordinator 910-a may facilitate transmissions by the device using a first portion of bandwidth during an active period of the communication pattern. Transmission coordinator 910-a may delay a transmission over a second portion of bandwidth to during an inactive period of the communication patter. In some cases, transmission coordinator 910-a may select a first MCS for the device to use to transmit during an active period of the communication pattern. The first MCS may lower than a second MCS used to transmit during an inactive period of the communication pattern. Transmission coordinator 910-a may (e.g., when included in a WLAN STA 115) facilitate the transmission of an indication of the determined communication pattern to a WLAN AP. Transmission coordinator may facilitate a SU-MIMO transmission during an active period of the communication pattern and/or a MU-MIMO transmission during an inactive period of the communication pattern. In some cases, the transmission coordinator 910-a may be a processor (e.g., a transceiver processor, or a radio processor, or a transmitter processor). The processor may be coupled with memory and execute instructions stored in the memory that enable the processor to perform or facilitate the communication pattern mitigation features discussed herein. A transmitter processor may be collocated with and/or communicate with (e.g., direct the operations of) a transmitter of the device.

The channel polling manager 1005 may facilitate the transmission of polling packets over the unlicensed radio frequency spectrum band. For example, the channel polling manager 1005 may facilitate the transmission an NDP from the device to a STA 115. In some cases, the channel polling manager 1005 may be a processor (e.g., a transceiver processor, or a radio processor, or a receiver processor). The processor may be coupled with memory and execute instructions stored in the memory that enable the processor to perform or facilitate the channel polling features discussed herein.

The communications monitor 1010 may determine which portions of the unlicensed radio frequency spectrum band are affected by the communication pattern. For example, the communications monitor 1010 may monitor signaling sent over the unlicensed radio frequency spectrum and determine that the communication pattern affects a first portion of bandwidth used by the device more than a second portion of bandwidth used by the device. The second portion of bandwidth may include at least a portion of the unlicensed radio frequency spectrum band. The communications monitor 1010 may determine the severity of the affects caused by the communication pattern on other devices. For example, the communications monitor 1010 may determine that a first set of WLAN devices served by the device (e.g., when the device is a WLAN AP) is more affected by the communication pattern than a second set of WLAN devices served by the WLAN AP. In some cases, the communications monitor 1010 may be a processor (e.g., a transceiver processor, or a radio processor, or a receiver processor). The processor may be coupled with memory and execute instructions stored in the memory that enable the processor to perform or facilitate the channel monitoring features discussed herein.

The received signal strength evaluator 1015 may evaluate the RSSI of a signal sent over the unlicensed radio frequency spectrum. For example the received signal strength evaluator may compare the RSSI of a signal to a threshold. In such a scenario, the communication pattern identifier 905-a may identifying the communication pattern based on the comparison of the RSSI to the threshold. In some cases, the received signal strength evaluator 1015 may be a processor (e.g., a transceiver processor, or a radio processor, or a receiver processor). The processor may be coupled with memory and execute instructions stored in the memory that enable the processor to perform or facilitate the signal evaluation features discussed herein.

The channel characteristic manager 1020 may facilitate the reception of a CSI message that is in response to an NDP. The CSI message may include an indication of a SINR associated with the unlicensed radio frequency spectrum band. In some cases, the signaling used to identify the communication pattern includes the indication of the SINR. For example, the signaling may include the indication of the SINR. In some cases, the SINR is a narrowband SINR associated with a portion of the unlicensed radio frequency spectrum band used by the device. In some cases, the channel characteristic manager 1020 may be a processor (e.g., a transceiver processor, or a radio processor, or a receiver processor). The processor may be coupled with memory and execute instructions stored in the memory that enable the processor to perform or facilitate the channel characteristic evaluation features discussed herein.

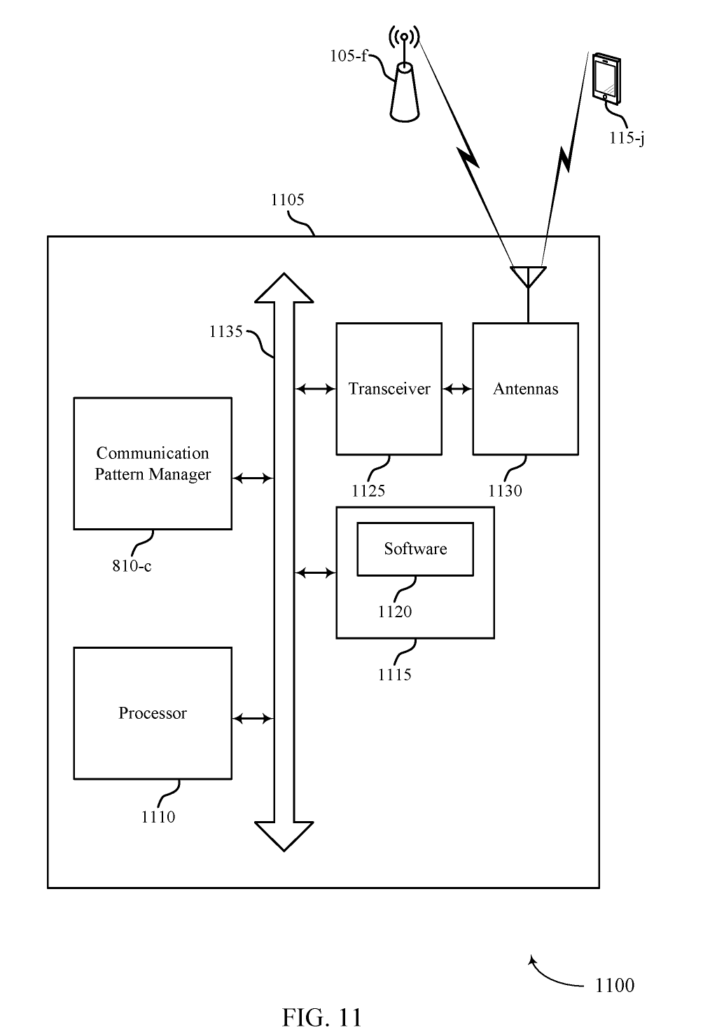

FIG. 11 shows a diagram of a system 1100 including a device 1105 that supports communication pattern detection for unlicensed radio frequency spectrum bands in accordance with aspects of the present disclosure. Device 1105 may be an example of a device 800, a device 900, an AP 105, or a STA 115 as described with reference to one or more of FIGS. 1-10. The device 1105 may communicate over an unlicensed radio frequency spectrum band using a first RAT (e.g., Wi-Fi). Other devices using a second RAT may access the unlicensed radio frequency spectrum band according to a communication pattern such as described with reference to FIGS. 1-10.

Device 1105 may include communication pattern manager 810-c, processor 1110, memory 1115, transceiver 1125, and antennas 1130. Each of these modules may communicate, directly or indirectly, with one another (e.g., via one or more buses 1135). The communication pattern manager 810-c may be an example of a communication pattern manager as described with reference to FIGS. 8-10. Communication pattern manager 810-c may identify the communication pattern (e.g., via signaling received by the device 1105) and adjust communications based on the identified communication pattern. The processor 1110 may include an intelligent hardware device, (e.g., a central processing unit (CPU), a microcontroller, an application specific integrated circuit (ASIC), etc.). The memory 1115 may include random access memory (RAM) and read only memory (ROM). The memory 1115 may store computer-readable, computer-executable software 1120 including instructions that, when executed, cause the processor to perform various functions described herein (e.g., communication pattern detection for unlicensed radio frequency spectrum bands, etc.). In some cases, the software 1120 may not be directly executable by the processor but may cause a computer (e.g., when compiled and executed) to perform functions described herein.

The transceiver 1125 may communicate bi-directionally, via one or more antennas, wired, or wireless links, with one or more networks, as described above. The transceiver 1125 may transmit and receive signals over unlicensed radio frequency spectrum. For example, the transceiver 1125 may receive transmissions (e.g., CTS-to-self or WWAN signals) over an unlicensed channel from a base station (not shown). When the device 1105 is an AP 105, the transceiver 1125 may send messages to STA 115-j (e.g., NPDs) and receive messages from STA 115-j (e.g., CSI reports). When the device 1105 is a STA 115, the transceiver 1125 may send messages to AP 105-f (e.g., CSI messages) and receive messages from AP 105-f (e.g., NDPs). The transceiver 1125 may receive or send indications of the communication pattern over the unlicensed radio frequency spectrum. The transceiver 1125 may include a modem to modulate packets and provide the modulated packets to the antennas 1130 for transmission, and to demodulate packets received from the antennas 1130. In some cases, the device 1105 may include a single of antennas 1130. However, in some cases the device may have more than one antennas 1130, which may be capable of concurrently transmitting or receiving multiple wireless transmissions.

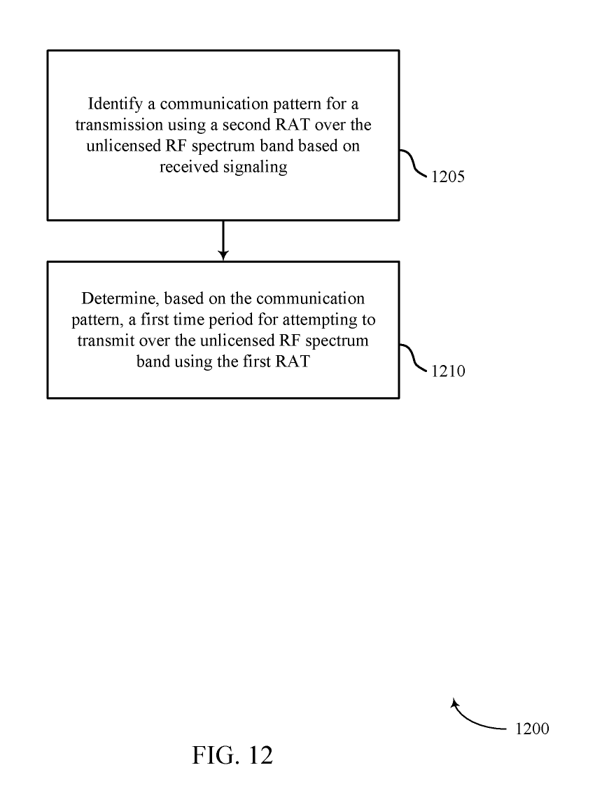

FIG. 12 shows a flowchart illustrating a method 1200 for communication pattern detection for unlicensed radio frequency spectrum bands in accordance with aspects of the present disclosure. The operations of method 1200 may be implemented by a device (e.g., a STA 115 or AP 105) or its components as described with reference to FIGS. 1-11. For example, the operations of method 1200 may be performed by the communication pattern manager as described herein. In some examples, the device may execute a set of codes to control the functional elements of the device to perform the functions described below. Additionally or alternatively, the device may perform aspects of the functions described below using special-purpose hardware. The device may use a first RAT and communicate over an unlicensed radio frequency spectrum band (e.g., an unlicensed channel).

At block 1205, the device may identify a communication pattern for a transmission using a second RAT over the unlicensed radio frequency spectrum band. The identification may be based on signaling received by the device as described above with reference to FIGS. 2-7B. The first RAT may be Wi-Fi technology and the second RAT may be LTE technology. The communication pattern may include a cyclical active period of time that WWAN signaling is present on the unlicensed radio frequency spectrum band and a cyclical inactive period of time that WWAN signaling is not present on the unlicensed radio frequency spectrum band.

In certain examples, the device may identify the communication pattern by detecting a WWAN pilot signal sent over the unlicensed radio frequency spectrum band. The WWAN pilot signal may be a WWAN PSS, a WWAN SSS, and/or a WWAN CRS. In some cases, the device may identify the communication patter by evaluating an RSSI corresponding to the signaling which is sent over the unlicensed radio frequency spectrum. By comparing the RSSI to a threshold, the device may determine whether WWAN signaling is present on the unlicensed radio frequency spectrum band. In certain examples, the operations of block 1205 may be performed or facilitated by the communication pattern identifier 905 as described with reference to FIG. 9.

At block 1210, the device may determine, based on the communication pattern, a first time period for attempting to transmit by the device over the unlicensed RF spectrum band using the first RAT as described above with reference to FIGS. 2 through 7B. In some cases, the device may select the MCS for the transmission. The MCS for the transmission may be high if the transmission occurs during the inactive period of the communication pattern and low if the transmission occurs during the active period of the communication pattern. In some cases, the transmission includes an indication of the communication pattern. In certain examples, the operations of block 1210 may be performed or facilitated by the transmission coordinator 910 as described with reference to FIG. 9.

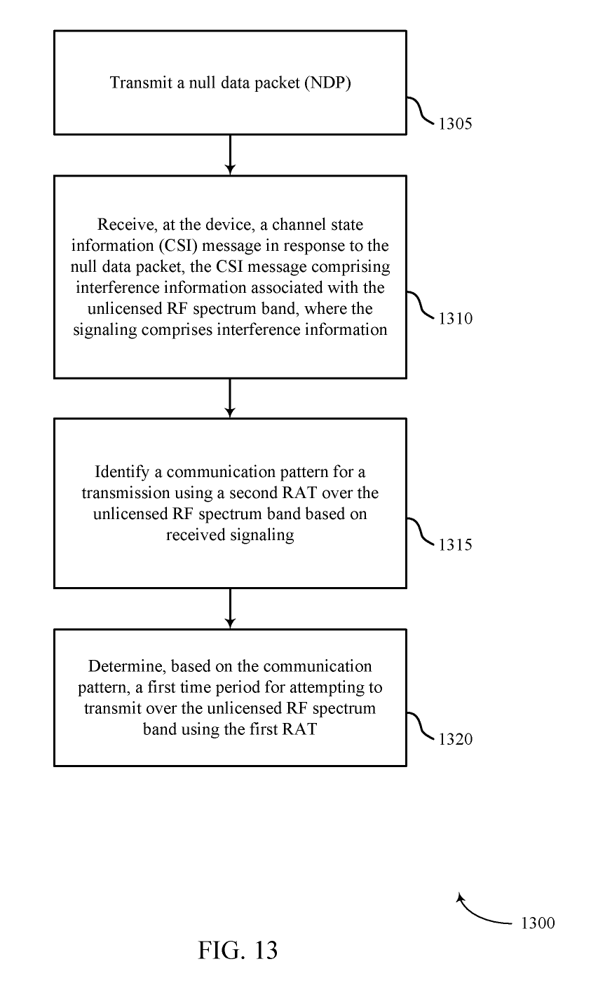

FIG. 13 shows a flowchart illustrating a method 1300 for communication pattern detection for unlicensed radio frequency spectrum bands in accordance with aspects of the present disclosure. The operations of method 1300 may be implemented by a device (e.g., a STA 115 or an AP 105) or its components as described with reference to FIGS. 1-11. For example, the operations of method 1300 may be performed by the communication pattern manager as described herein. In some examples, the device may execute a set of codes to control the functional elements of the device to perform the functions described below. Additionally or alternatively, the device may perform aspects the functions described below using special-purpose hardware. The device may use a first RAT and communicate over an unlicensed radio frequency spectrum band (e.g., an unlicensed channel).

At block 1305, the device may transmit an NDP as described above with reference to FIGS. 2-7. The NDP may be sent over the unlicensed radio frequency spectrum band. In certain examples, the operations of block 1305 may be performed or facilitated by the channel polling manager 1005 as described with reference to FIG. 10. At block 1310, the device may receive a CSI message in response to the NDP. The CSI message may include interference information associated with the unlicensed RF spectrum band as described above with reference to FIGS. 2 through 7. In some cases, the interference information is a narrowband SINR associated with a portion of the unlicensed radio frequency spectrum band used by the device. In certain examples, the operations of block 1310 may be performed or facilitated by the channel characteristic manager 1020 as described with reference to FIG. 10.

At block 1315, the device may identify a communication pattern for a transmission using a second RAT over the unlicensed RF spectrum band based on signaling received by the device as described above with reference to FIGS. 2-7B. The signaling may include the CSI and corresponding interference information. In certain examples, the operations of block 1315 may be performed or facilitated by the communication pattern identifier 905 as described with reference to FIG. 9. At block 1320, the device may determine, based on the communication pattern, a first time period for attempting to transmit by the device over the unlicensed radio frequency spectrum band using the first RAT as described above with reference to FIGS. 2-7B. In certain examples, the operations of block 1320 may be performed or facilitated by the transmission coordinator 910 as described with reference to FIG. 9.

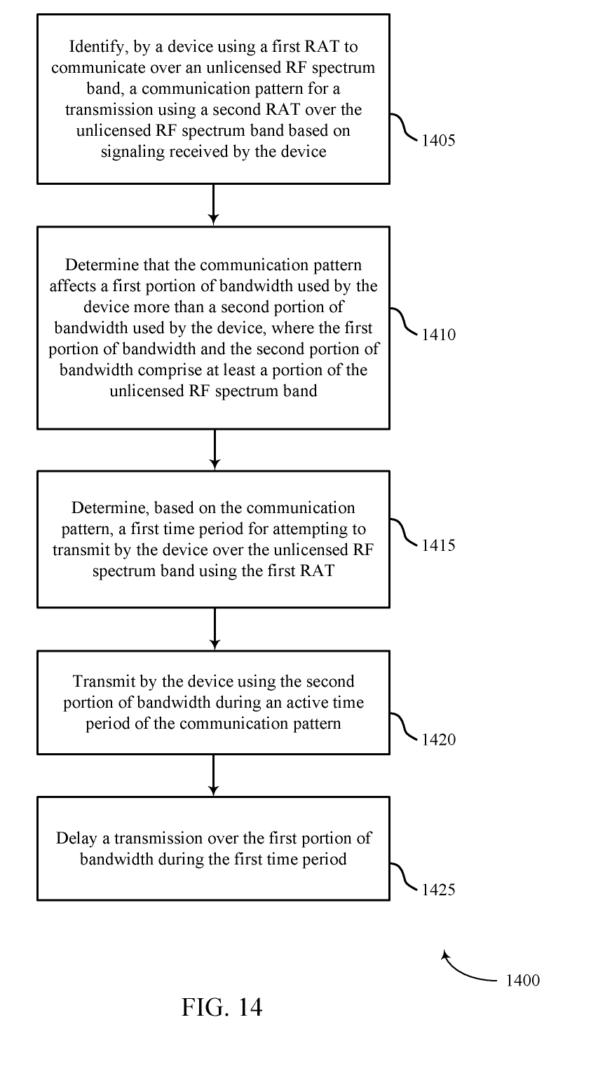

FIG. 14 shows a flowchart illustrating a method 1400 for communication pattern detection for unlicensed radio frequency spectrum bands in accordance with aspects of the present disclosure. The operations of method 1400 may be implemented by a device (e.g., a STA 115 or an AP 105) or its components as described with reference to FIGS. 1-11. For example, the operations of method 1400 may be performed by the communication pattern manager as described herein. In some examples, the device may execute a set of codes to control the functional elements of the device to perform the functions described below. Additionally or alternatively, the device may perform aspects the functions described below using special-purpose hardware. The device may use a first RAT and communicate over an unlicensed radio frequency spectrum band (e.g., an unlicensed channel).

At block 1405, the device may identify a communication pattern for a transmission using a second RAT over the unlicensed RF spectrum band based on signaling received by the device as described above with reference to FIGS. 2-7B. In certain examples, the operations of block 1405 may be performed or facilitated by the communication pattern identifier 905 as described with reference to FIG. 9. At block 1410, the device may determine that the communication pattern affects a first portion of bandwidth used by the device more than a second portion of bandwidth used by the device, where the first portion of bandwidth and the second portion of bandwidth may include at least a portion of the unlicensed radio frequency spectrum band as described above with reference to FIGS. 2-7B. In certain examples, the operations of block 1415 may be performed or facilitated by the communications monitor 1010 as described with reference to FIG. 10.

At block 1415, the device may determine, based on the communication pattern, a first time period for attempting to transmit by the device over the unlicensed RF spectrum band using the first RAT as described above with reference to FIGS. 2-7B. In certain examples, the operations of block 1415 may be performed or facilitated by the transmission coordinator 910 as described with reference to FIG. 9. At block 1420, the device may transmit using the second portion of bandwidth during an active period of the communication pattern as described above with reference to FIGS. 2-7B. In certain examples, the operations of block 1420 may be performed or facilitated by the transmission coordinator 910 as described with reference to FIG. 9. At block 1425, the device may delay a transmission over the first portion of bandwidth during the first time period as described above with reference to FIGS. 2-7B. In certain examples, the operations of block 1425 may be performed or facilitated by the transmission coordinator 910 as described with reference to FIG. 9.

It should be noted that these methods describe possible implementation, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein. Thus, aspects of the disclosure may provide for communication pattern detection for unlicensed radio frequency spectrum bands.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different PHY locations. Also, as used herein, including in the claims, “or” as used in a list of items (for example, a list of items prefaced by a phrase such as “at least one of” or “one or more”) indicates an inclusive list such that, for example, a list of at least one of A, B, or C means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as (Global System for Mobile communications (GSM)). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunications system (Universal Mobile Telecommunications System (UMTS)). 3GPP LTE and LTE-advanced (LTE-A) are new releases of UMTS that use E-UTRA. UTRA, E-UTRA, UMTS, LTE, LTE-a, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description herein, however, describes an LTE system for purposes of example, and LTE terminology is used in much of the description above, although the techniques are applicable beyond LTE applications.

The wireless communications system or systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The DL transmissions described herein may also be called forward link transmissions while the UL transmissions may also be called reverse link transmissions. Each communication link described herein including, for example, wireless communications system 100 and 200 of FIGS. 1 and 2 may include one or more carriers, where each carrier may be a signal made up of multiple sub-carriers (e.g., waveform signals of different frequencies). Each modulated signal may be sent on a different sub-carrier and may carry control information (e.g., reference signals, control channels, etc.), overhead information, user data, etc. The communication links described herein (e.g., communication links 120 of FIG. 1) may transmit bidirectional communications using frequency division duplex (FDD) (e.g., using paired spectrum resources) or time division duplex (TDD) operation (e.g., using unpaired spectrum resources). Frame structures may be defined for FDD (e.g., frame structure type 1) and TDD (e.g., frame structure type 2).

The various illustrative blocks and modules described in connection with the disclosure herein may be implemented or performed with a general-purpose processor, a digital signal processor (DSP), an ASIC, an field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be performed by one or more other processing units (or cores), on at least one integrated circuit (IC). In various examples, different types of ICs may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

What is claimed is:

1. A method of wireless communication comprising:
identifying, by a device using a first radio access technology (RAT) to communicate over an unlicensed radio frequency (RF) spectrum band, a communication pattern for a transmission using a second RAT over the unlicensed RF spectrum band based at least in part on signaling received by the device; and
determining, based at least in part on the communication pattern, a first time period for attempting to transmit by the device over the unlicensed RF spectrum band using the first RAT.

2. The method of claim 1, further comprising:
transmitting a null data packet (NDP) from the device; and
receiving, at the device, a channel state information (CSI) message in response to the NDP, the CSI message comprising interference information associated with the unlicensed RF spectrum band, wherein the signaling comprises interference information.

3. The method of claim 1, further comprising:
determining that the communication pattern affects a first portion of bandwidth used by the device more than a second portion of bandwidth used by the device, wherein the first portion of bandwidth and the second portion of bandwidth comprise at least a portion of the unlicensed RF spectrum band;
transmitting by the device using the second portion of bandwidth during an active time period of the communication pattern; and
delaying a transmission over the first portion of bandwidth during the first time period.

4. The method of claim 1, further comprising:
selecting, for the device using the first RAT, a first modulation and coding scheme (MCS) to use to transmit during an active time period of the communication pattern, wherein the first MCS is lower than a second MCS to use for transmissions during the first time period.

5. The method of claim 1, wherein identifying the communication pattern comprises:
detecting a wireless wide area network (WWAN) pilot signal sent over the unlicensed RF spectrum band, or evaluating a received signal strength indicator (RSSI) corresponding to signaling sent over the unlicensed RF spectrum band, or a combination thereof.

6. The method of claim 1, further comprising:
configuring the device to transmit a single-user multiple input multiple output (MIMO) transmission during the first time period, wherein the device is a wireless local area network access point and the first time period comprises an active time period of the communication pattern; and
configuring the device to transmit a multi-user MIMO transmission during a second time period, wherein the second time period comprises an inactive time period of the communication pattern.

7. The method of claim 1, further comprising:
determining that a first set of WLAN devices served by the device is more affected by the communication pattern than a second set of WLAN devices served by the device;
transmitting to the second set of WLAN devices during an active time period of the communication pattern; and
delaying transmitting to the first set of WLAN devices to during the first time period.

8. An apparatus for wireless communication comprising:
means for identifying, by the apparatus using a first radio access technology (RAT) to communicate over an unlicensed radio frequency (RF) spectrum band, a communication pattern for a transmission using a second RAT over the unlicensed RF spectrum band based at least in part on signaling received by the apparatus; and
means for determining, based at least in part on the communication pattern, a first time period for attempting to transmit by the apparatus over the unlicensed RF spectrum band using the first RAT.

9. The apparatus of claim 8, further comprising:
means for transmitting a null data packet (NDP); and
means for receiving a channel state information (CSI) message in response to the NDP, the CSI message comprising interference information associated with the unlicensed RF spectrum band, wherein the signaling comprises interference information.

10. The apparatus of claim 8, further comprising:
means for determining that the communication pattern affects a first portion of bandwidth used by the device more than a second portion of bandwidth used by the device, wherein the first portion of bandwidth and the second portion of bandwidth comprise at least a portion of the unlicensed RF spectrum band;
means for transmitting using the second portion of bandwidth during an active time period of the communication pattern; and
means for delaying a transmission over the first portion of bandwidth during the first time period.

11. The apparatus of claim 8, further comprising:
means for selecting, for the device using the first RAT, a first modulation and coding scheme (MCS) to use to transmit during an active time period of the communication pattern, wherein the first MCS is lower than a second MCS to use for transmissions during the first time period.

12. The apparatus of claim 8, wherein the means for identifying the communication pattern comprises:
means for detecting a wireless wide area network (WWAN) pilot signal sent over the unlicensed RF spectrum band, or means for evaluating a received signal strength indicator (RSSI) corresponding to signaling sent over the unlicensed RF spectrum band, or a combination thereof.

13. The apparatus of claim 8, further comprising:
means for determining that a first set of wireless local area network (WLAN) devices served by the apparatus is more affected by the communication pattern than a second set of WLAN devices served by the apparatus;
means for transmitting to the second set of WLAN devices during an active time period of the communication pattern; and
means for delaying transmitting to the first set of WLAN devices to during the first time period.

14. An apparatus for wireless communication, comprising:
a memory that stores instructions; and
a processor coupled with the memory, wherein the processor and the memory are configured to:
identify, using a first radio access technology (RAT) to communicate over an unlicensed radio frequency (RF) spectrum band, a communication pattern for a transmission using a second RAT over the unlicensed RF spectrum band based at least in part on signaling received by the apparatus; and
determine, based at least in part on the communication pattern, a first time period for attempting to transmit by the apparatus over the unlicensed RF spectrum band using the first RAT.

15. The apparatus of claim 14, wherein:
the first RAT comprises wireless fidelity (Wi-Fi) technology; and
the second RAT comprises Long Term Evolution (LTE) technology.

16. The apparatus of claim 14, wherein the processor and the memory are configured to:
transmit a null data packet (NDP) from the apparatus; and
receive a channel state information (CSI) message in response to the NDP, the CSI message comprising interference information associated with the unlicensed RF spectrum band, wherein the signaling comprises interference information.

17. The apparatus of claim 16, wherein the interference information is a narrowband signal-to-noise-plus-interference ratio (SINR) associated with a portion of the unlicensed RF spectrum band used by the apparatus.

18. The apparatus of claim 14, wherein the processor and the memory are configured to:
determine that the communication pattern affects a first portion of bandwidth used by the apparatus more than a second portion of bandwidth used by the apparatus, wherein the first portion of bandwidth and the second portion of bandwidth comprises at least a portion of the unlicensed RF spectrum band;
transmit using the second portion of bandwidth during an active time period of the communication pattern; and
delay a transmission over the first portion of bandwidth during the first time period.

19. The apparatus of claim 14, wherein the processor and the memory are configured to:
select, for the device using the first RAT, a first modulation and coding scheme (MCS) to use to transmit during an active time period of the communication pattern, wherein the first MCS is lower than a second MCS to use for transmissions during the first time period.

20. The apparatus of claim 14, wherein the processor and the memory are configured to:
detect a wireless wide area network (WWAN) pilot signal sent over the unlicensed RF spectrum band.

21. The apparatus of claim 20, wherein the WWAN pilot signal comprises at least a WWAN primary synchronization signal (PSS), or a WWAN secondary synchronization signal (SSS), or a WWAN cell-specific reference signal (CRS), or a combination thereof.

22. The apparatus of claim 14, wherein the processor and the memory are configured to:
evaluate a received signal strength indicator (RSSI) corresponding to the signaling, wherein the signaling is sent over the unlicensed RF spectrum band.

23. The apparatus of claim 22, wherein the processor and the memory are configured to:
compare the RSSI to a threshold; and
determine whether WWAN signaling is present on the unlicensed RF spectrum band based at least in part on the comparison.

24. The apparatus of claim 14, wherein:
the apparatus is a wireless local area network (WLAN) station; and
the processor and the memory are configured to cause the WLAN station to transmit an indication of the identified communication pattern to a WLAN access point (AP).

25. The apparatus of claim 14, wherein the apparatus comprises a wireless local area network (WLAN) access point (AP).

26. The apparatus of claim 25, wherein the processor and the memory are configured to cause the WLAN AP to:
configure the WLAN AP to transmit a single-user multiple input multiple output (MIMO) transmission during the first time period.

27. The apparatus of claim 26, wherein the processor and the memory are configured to cause the WLAN AP to:
configure the WLAN AP to transmit a multi-user MIMO transmission during a second time period, wherein the first time period comprises an active time period of the communication pattern and the second time period comprises an inactive time period of the communication pattern.

28. The apparatus of claim 25, wherein the processor and the memory are configured to:
determine that a first set of WLAN devices served by the WLAN AP is more affected by the communication pattern than a second set of WLAN devices served by the WLAN AP;
transmit to the second set of WLAN devices during an active time period of the communication pattern; and
delay transmitting to the first set of WLAN devices to during the first time period.

29. The apparatus of claim 14, wherein the communication pattern comprises a cyclical active period of time that wireless wide area network (WWAN) signaling is present on the unlicensed RF spectrum band and a cyclical inactive period of time that WWAN signaling is not present on the unlicensed RF spectrum band.

30. A non-transitory computer-readable medium storing code for wireless communication, the code comprising instructions executable to:
identify, by a device using a first radio access technology (RAT) to communicate over an unlicensed radio frequency (RF) spectrum band, a communication pattern for a transmission using a second RAT over the unlicensed RF spectrum band based at least in part on signaling received by the device; and
determine, based at least in part on the communication pattern, a first time period for attempting to transmit by the device over the unlicensed RF spectrum band using the first RAT.
